(19) United States
(12) Patent Application Publication
(10) Pub. No.: US 2024/0147317 A1
(43) Pub. Date: May 2, 2024

(54) METHOD AND APPARATUS SUPPORTING SELFCONFIGURATION AND SELF-OPTIMIZATION

(71) Applicant: Samsung Electronics Co., Ltd., Suwon-si (KR)

(72) Inventors: Lixiang XU, Beijing (CN); Weiwei WANG, Beijing (CN); Hong WANG, Beijing (CN)

(21) Appl. No.: 18/500,871

(22) Filed: Nov. 2, 2023

(30) Foreign Application Priority Data
Nov. 2, 2022 (CN) 202211367421.9
Nov. 11, 2022 (CN) 202211414708.2
Apr. 17, 2023 (CN) 202310409434.6

(51) Int. Cl. H04W 36/00; H04W 36/32; H04W 36/36

(52) U.S. Cl. CPC H04W 36/0061; H04W 36/322; H04W 36/362

(57) ABSTRACT

The disclosure relates to a 5G or 6G communication system for supporting a higher data transmission rate. A method performed by a user equipment (UE) is provided. The method includes transmitting, to a base station, a first message including information that a successful primary secondary cell (PSCell) report is available; receiving, from the base station, a second message requesting for the successful PSCell report; and transmitting, to the base station, a third message including the successful PSCell report.

### CROSS-REFERENCE TO RELATED APPLICATIONS

This application is based on and claims priority under 35 U.S.C. § 119 to Chinese Patent Application No. 202211367421.9, filed Nov. 2, 2022, Chinese Patent Application No. 202211414708.2, filed Nov. 11, 2022, and Chinese Patent Application No. 202310409434.6, filed Apr. 17, 2023, in the Chinese Intellectual Property Office, the disclosure of which is incorporated by reference herein in its entirety.

### BACKGROUND

### 1. Field

The application relates to wireless communication technology, in particular to a method and apparatus supporting self-configuration and self-optimization.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### SUMMARY

How to support self-configuration and self-optimization in dual connectivity or self-configuration and self-optimization for the risk of potential failure in the process of successful handover or successful PSCell (SpCell (primary cell of a master or secondary cell group) of a secondary cell group PSCell) change is a problem that needs to be solved at present.

In an embodiment, a method performed by a user equipment (UE) is provided. The method includes transmitting, to a base station, a first message including information that a successful primary secondary cell (PSCell) report is available; receiving, from the base station, a second message requesting for the successful PSCell report; and transmitting, to the base station, a third message including the successful PSCell report.

In an embodiment, a method performed by a base station is provided. The method includes receiving, from a UE, a first message including information that a successful PSCell report is available; transmitting, to the UE, a second message requesting for the successful PSCell report; and receiving, from the UE, a third message including the successful PSCell report.

In an embodiment, a UE in a wireless communication system is provided. The UE includes a transceiver and a controller. The controller is configured to transmit, to a base station via the transceiver, a first message including information that a successful PSCell report is available, receive, from the base station via the transceiver, a second message requesting for the successful PSCell report, and transmit, to the base station via the transceiver, a third message including the successful PSCell report.

In an embodiment, a base station in a wireless communication system is provided. The base station includes a transceiver and a controller. The controller is configured to receive, from a UE via the transceiver, a first message including information that a successful PSCell report is available, transmit, to the UE via the transceiver, a second message requesting for the successful PSCell report, and receive, from the UE via the transceiver, a third message including the successful PSCell report.

According to one aspect of the present disclosure, a method executed by a first network node of a communication system is provided, including: receiving first configuration information of a successful PSCell report from a second network node; receiving second configuration information of the successful PSCell report from a third network node; and transmitting the first configuration information of the successful PSCell report and the second configuration information of the successful PSCell report to a UE.

According to an embodiment of the present disclosure, corresponding to a case that the second network node is a target secondary node, the first configuration information of the successful PSCell report includes a threshold value of a timer T304.

According to an embodiment of the present disclosure, corresponding to a case that the second network node is a source secondary node, the first configuration information of the successful PSCell report includes a threshold value of a timer T310 and/or a threshold value of a timer T312.

According to an embodiment of the present disclosure, corresponding to a case that the second network node is a target master base station, the target master base station can also obtain the first configuration information of the PSCell report from a target secondary base station. The first configuration information of the successful PSCell report includes a threshold value of a timer T304.

Corresponding to a case that the third network node is a source secondary node, the second configuration information of the successful PSCell report includes a threshold value of a timer T310 and/or a threshold value of a timer T312.

Corresponding to a case that the third network node is a target secondary node, the second configuration information of the successful PSCell report includes a threshold value of a timer T304. The threshold value is a threshold percentage of the timer.

Corresponding to a case that the second network node is a target master base station, the target master base station may also obtain the first configuration information of the PSCell report from a target secondary base station. The first configuration information of the successful PSCell report includes a threshold value of a timer T304.

According to an embodiment of the present disclosure, the threshold value is a threshold percentage of the timer.

According to another aspect of the present disclosure, a method supporting self-configuration and self-optimization is provided, including: requesting, by a master node, first configuration information of a successful PSCell change from a source secondary node; receiving, by the master node, first configuration information of a successful PSCell report from the source secondary node; receiving, by the master node, second configuration information of the successful PSCell report from a target secondary node; and transmitting, by the master node, the first configuration information of the successful PSCell report and/or the second configuration information of the successful PSCell report to a UE.

According to an embodiment of the present disclosure, the first configuration information includes a threshold value of a timer T310 and/or a threshold value of a timer T312. The threshold value is a threshold percentage of the timer.

According to an embodiment of the present disclosure, a message that the master node requests the first configuration information of the successful PSCell change from the source secondary node may be a SN (secondary node) modification request message or other messages. The message includes indication information requesting the first configuration information of the PSCell report or includes indication information requesting the threshold value of the T310 and the threshold value of the T312, or includes indication information requesting the threshold value of the T310 and/or indication information requesting the threshold value of the T312.

According to an embodiment of the present disclosure, the master node receives the first configuration information of the successful PSCell report from the source secondary node via a secondary node request acknowledgement message or other messages. The first configuration information includes the threshold value of the timer T310 and/or the threshold value of the timer T312.

According to an embodiment of the present disclosure, the second configuration information of the successful PSCell report includes the threshold value of the timer T304. The threshold value is a threshold percentage of the timer.

According to another aspect of the present disclosure, a method supporting self-configuration and self-optimization is provided, including: receiving, by a first network node, first configuration information of a successful PSCell report and/or second configuration information of a successful PSCell report from a second network node; and transmitting, by the first network node, the first configuration information of the successful PSCell report and/or the second configuration information of the successful PSCell report to a UE.

According to an embodiment of the present disclosure, the first configuration information of the successful PSCell change includes a threshold value of a timer T304, and the second configuration information of the successful PSCell report includes a threshold value of a timer T310 and/or a threshold value of a timer T312. The threshold value is a threshold percentage of the timer.

According to an embodiment of the present disclosure, corresponding to a process of a PSCell addition or a conditional PSCell addition, the first network node receives the first configuration information of the successful PSCell report from the second network node.

According to the embodiment of the present disclosure, corresponding to the process of PSCell addition or conditional PSCell addition, the first network node transmits the first configuration information of the successful PSCell report to the UE.

According to another aspect of the present disclosure, a method supporting self-configuration and self-optimization is provided, including: receiving, by a first network node, information that a successful PSCell report is available; requesting, by the first network node, the successful PSCell report from UE; receiving, by the first network node, the successful PSCell report from the UE; and transmitting, by the first network node, the successful PSCell report to a node configuring the trigger of the successful PSCell report.

According to an embodiment of the present disclosure, the first network node may receive the information that the successful PSCell report is available via an RRC reconfiguration complete message or other messages.

According to an embodiment of the present disclosure, the first network node may request the successful PSCell report via UE information request message or other messages.

According to an embodiment of the present disclosure, the UE may transmit the information of the successful PSCell report to the first network node via UE information response message or other RRC messages.

According to an embodiment of the present disclosure, the successful PSCell report includes one or more of the following information:
time from receiving the successful PSCell report configuration to transmitting the successful PSCell report;
time from maintaining the successful PSCell report by the UE to transmitting the successful PSCell report;
cell information of a primary cell at the time of PSCell change, wherein the cell information of the primary cell includes a cell identifier of the primary cell, and/or an identifier of a tracking area where the primary cell is located, and the PSCell change corresponds to the PSCell change corresponding to the successful PSCell report;
cell information of a source PSCell, wherein the cell information includes a cell identifier of the cell and/or an identifier of a tracking area where the cell belongs;
a cell identifier of a target PSCell, wherein the cell information includes a cell identifier of the cell and/or an identifier of a tracking area where the cell belongs;
a cell-radio network temporary identifier (C-RNTI) allocated by the source PSCell;
a C-RNTI allocated by the target PSCell;
UE location information;
causes for successful PSCell report, wherein the causes for the successful PSCell report in the message transmitted by the UE may also include a cause of a timer T316;
common random-access information;
for CPC (Conditional PSCell Change) or CPA (Conditional PSCell addition), the successful PSCell report transmitted by the UE may also include the time from CPC or CPA configuration to CPC or CPA execution.

A measurement result of the UE.

According to an embodiment of the present disclosure, the successful PSCell report may be encoded in an RRC format supported by the first network node or in an RRC format supported by a network node that triggers the successful PSCell report.

According to an embodiment of the present disclosure, if the successful PSCell report is not encoded in the RRC format supported by the first network node, an RRC message for transmitting the successful PSCell report also includes cell information of a cell configuring the trigger of the successful PSCell report.

According to an embodiment of the present disclosure, the cell information includes a cell identifier and/or a tracking area identifier. The cell information is included outside the successful PSCell report.

According to an embodiment of the present disclosure, if the successful PSCell report is caused by a successful PSCell change configuration configured by a source SN, the first network node transmits the successful PSCell report to the source SN.

According to an embodiment of the present disclosure, if the successful PSCell report is caused by a successful PSCell change configuration configured by a target SN, the first network node transmits the successful PSCell report to the target SN.

According to an embodiment of the present disclosure, if the successful PSCell report is not encoded in an RRC format supported by the node configuring the trigger of a successful handover report, the first network node converts the successful PSCell report encoded in the RRC format of the first network node into an inter-node message encoded in an RRC format supported by the node configuring the trigger of the successful handover report or into an information element (e.g., XnAP information element) of an inter-base station message, and then transmits the converted inter-node message or information element to the node configuring the trigger of the successful handover report. The inter-node message may also be referred to as an inter-node RRC message.

According to an embodiment of the present disclosure, if the first network node is not the master node at the time of successful PSCell change, the first network node transmits the successful PSCell report to a master node serving the UE at the time of the successful PSCell change, and the master node further determines to transmit the successful PSCell report to a source SN or a target SN. If the successful PSCell report is caused by a successful PSCell change configuration configured by the source SN, the first network node transmits the successful PSCell report to the source SN. If the successful PSCell report is caused by a successful PSCell change configuration configured by the target SN, the first network node transmits the successful PSCell report to the target SN.

According to an embodiment of the present disclosure, if the first network node is not the master node at the time of successful PSCell change, the first network node directly transmits the successful PSCell report to the source SN or the target SN. The first network node determines to transmit the successful PSCell report to the source SN or the target SN according to the cause of the successful handover report. If the successful PSCell report is caused by a successful PSCell change configuration configured by the source SN, the first network node transmits the successful PSCell report to the source SN. If the successful PSCell report is caused by a successful PSCell change configuration configured by the target SN, the first network node transmits the successful PSCell report to the target SN.

According to an embodiment of the present disclosure, if the first network node is not the master node at the time of successful PSCell change, and if the first network node is a target secondary node of the successful PSCell change, and the successful PSCell report is caused by the configuration of a source PSCell, the first network node transmits the successful PSCell report to the source SN, the first node network may directly transmit the successful PSCell report to the source SN, or transmit the successful PSCell report to the source SN via a MN (master node). The first network node transmits the successful PSCell report to the MN according to an identifier of a primary cell in the successful PSCell report, and the MN transmits a successful handover report to the source SN.

According to an embodiment of the present disclosure, if the first network node is not a master node at the time of successful PSCell change, and if the first network node is a source secondary node of the successful PSCell change, and the successful PSCell report is caused by the configuration of a target PSCell, the first network node transmits the successful PSCell report to the target SN, the first node network may directly transmit the successful PSCell report to the target SN, or transmit the successful PSCell report to the target SN via a MN. The first network node transmits the successful PSCell report to the MN according to an identifier of a primary cell in the successful PSCell report, and the MN transmits a successful handover report to the target SN.

According to an embodiment of the present disclosure, if the first network node is not a master node at the time of successful PSCell change, a message transmitted by the first network node to the source SN or the target SN or the MN includes a UE identifier, which may be the C-RNTI of the UE at the target PSCell, the C-RNTI of the UE at the source PSCell, a UE access layer (AP) identifier of the UE at the first network node, a UE AP ID of the UE at the master node, a UE AP ID of the UE at the source SN, and/or a UE AP ID of the UE at the target SN.

According to an embodiment of the present disclosure, if the first network node is not a master node at the time of the successful PSCell change, the node configuring the trigger of the successful PSCell report is to optimize the subsequent PSCell change, to avoid potential failures.

According to another aspect of the present disclosure, a first network node in a communication system is provided, including: a transceiver, configured to transmit and receive a signal; and a controller, coupled to the transceiver and configured to perform operations in the method according to the present disclosure.

According to another aspect of the present disclosure, a user equipment UE in a communication system is provided, including: a transceiver, configured to transmit and receive a signal; and a controller, coupled to the transceiver and configured to perform operations in the method according to the present disclosure.

With the method supporting self-configuration and self-optimization of the present disclosure, potential failures can be correctly identified in the case of successful PSCell change in a dual connection state or successful SN change in the process of SN change during handover, so as to perform reasonable optimization to avoid occurrence of failures, guarantee service continuity and reduce labour costs of operators.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates a system architecture diagram of a SAE according to embodiments of the present disclosure;

FIG. 2 illustrates an initial overall architecture of 5G according to embodiments of the present disclosure;

FIG. 3 illustrates a flow diagram of a method I supporting self-configuration and self-optimization according to embodiments of the present disclosure;

FIG. 4 illustrates a flow diagram of a method II supporting self-configuration and self-optimization according to embodiments of the present disclosure;

FIG. 5 illustrates a flow diagram of a method III supporting self-configuration and self-optimization according to embodiments of the present disclosure;

FIG. 6 illustrates a flow diagram of a method IV supporting self-configuration and self-optimization according to embodiments of the present disclosure;

FIG. 7 illustrates a flow diagram of an embodiment I supporting self-configuration and self-optimization according to embodiments of the present disclosure;

FIG. 8 illustrates a flow diagram of an embodiment II supporting self-configuration and self-optimization according to embodiments of the present disclosure;

FIG. 9 illustrates a flow diagram of an embodiment III supporting self-configuration and self-optimization according to embodiments of the present disclosure;

FIG. 10 illustrates a flow diagram of an embodiment IV supporting self-configuration and self-optimization according to embodiments of the present disclosure;

FIG. 11 illustrates a network node according to embodiments of the present disclosure; and

FIG. 12 illustrates a UE according to embodiments of the present disclosure.

### DETAILED DESCRIPTION

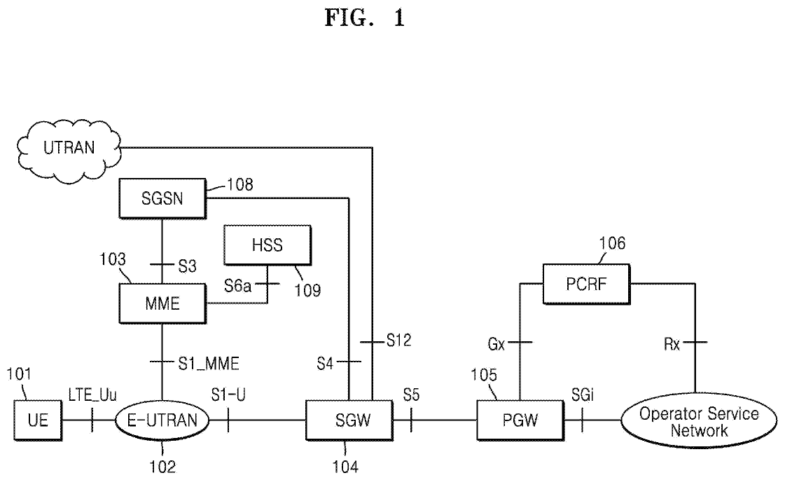

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to make the purposes, technical solutions and advantages of embodiments of the present disclosure more clearly, the technical solution of the embodiments of the present disclosure will be described clearly and thoroughly below in connection with accompanying drawings of embodiments of the present disclosure. Apparently, the described embodiments are a part rather than all embodiments. All other embodiments obtained by those of ordinary skill in the art based on the described embodiments of the present disclosure without creative labour shall fall within the protection scope of the present disclosure.

Before proceeding with the following description of specific implementation it may be advantageous to elaborate on the definitions of certain words and phrases used throughout this patent document. The term “coupling” and its derivatives refers to any direct or indirect communication between two or more elements, regardless of whether the elements are in physical contact with each other. The terms “transmit,” “receive,” and “communicate” and their derivatives cover both direct and indirect communication. The terms “comprising” and “including” and their derivatives mean including but not limited to. The term “or” is inclusive and means and/or. The phrase “associated with” and its derivatives means including, included in, connected to, interconnected with, containing, contained in, connected to or connected with, coupled to or coupled with, capable of communicating with, cooperating with, interleaving, juxtaposing, proximate, bound to or bound with, having, having an attribute of, having a relation or having a relation with, etc. The term “controller” means any device, system, or part thereof that controls at least one operation. Such a controller may be implemented in hardware or in a combination of hardware and software and/or firmware. The functionality associated with any particular controller can be centralized or distributed locally or remotely. When used with an item list, the phrase “at least one of . . . ” means that different combinations of one or more listed items can be used, and only one item in the list may be needed. For example, “at least one of A, B, and C” includes any of the following combinations: A, B, C; A and B; A and C; B and C; and A and B and C. For example, “at least one of A, B, or C” includes any of the following combinations: A, B, C; A and B; A and C; B and C; and A and B and C.

Further, the various functions described below may be implemented or supported by one or more computer programs each formed from computer-readable program code and embodied in a computer-readable medium. The terms “application” and “program” refer to one or more computer programs, software components, instruction sets, procedures, functions, objects, classes, instances, related data, or portions thereof suitable for implementation in appropriate computer-readable program code. The phrase “computer readable program code” includes any type of computer code, including source code, object code, and executable code. The phrase “computer-readable media” includes any type of media that can be accessed by a computer, such as Read-Only Memory (ROM), Random Access Memory (RAM), hard disk drive, optical disc (CD), digital video disc (DVD), or any other type of memory. “Non-transitory” computer-readable media exclude wired, wireless, optical, or other communication links for the transmission of transient electrical or other signals. Non-transitory computer-readable media include media that can permanently store data and media that can store and later rewrite data, such as a rewritable optical disc or an erasable memory device.

Terms used herein to describe embodiments of the present application are not intended to limit and/or define the scope of the present application. For example, unless otherwise defined, technical or scientific terms used in the present disclosure should have a general meaning as understood by a person of ordinary skill in the art to which the application pertains.

It should be understood that the words “first,” “second,” and the like used in the present disclosure do not denote any order, quantity, or importance, but are merely used to distinguish between different components. Unless the context clearly dictates otherwise, the singular forms of “an,” “a,” or “the” and the like do not denote quantitative restrictions, but rather denote the existence of at least one.

As used herein, any reference to “an example” or “example,” “an embodiment” or “embodiment” means that particular elements, features, structures, or characteristics described in connection with the embodiment are included in at least one embodiment. The phrases “in an embodiment” or “in an example” appearing in different places in the specification do not necessarily all refer to the same embodiment.

As used herein, “a part” of something means “at least some” of it, and therefore may mean less than all or all of it. Thus, a “part” of a thing includes the whole thing as a special case, that is, the whole thing is an example of a part of a thing.

It will be further understood that the terms “comprising” or “including” and the like mean that elements or objects appearing before the word encompass elements or objects enumerated after the word and their equivalents, without excluding other elements or objects. Words like “connected” or “linked” etc. are not limited to physical or mechanical connections, but may include electrical connections, whether direct or indirect. “Up,” “down,” “left,” “right,” etc. are used only to indicate a relative positional relation, which may change accordingly when the absolute position of the described object is changed.

Various embodiments discussed below and used to describe the principles of the present disclosure in this patent document are for illustration only and should not be interpreted in any way to limit the scope of the present disclosure. Those skilled in the art will appreciate that the principles of the present disclosure may be implemented in any suitably arranged wireless communication system. For example, while the following detailed description of the embodiments of the present disclosure will focus on LTE and 5G communication systems, those skilled in the art may appreciate that the main points of the present disclosure can also be applied to other communication systems with similar technical backgrounds and channel formats with slight modifications without departing from the scope of the present disclosure substantially. The technical solution of the embodiments of the present application can be applied to various communication systems, for example, the communication system may include a global system for mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, and an LTE time division duplex system (TDD), a universal mobile telecommunication system (UMTS), a worldwide interoperability for microwave access (WiMAX) communication system, a 5th generation (5G) system or new radio (NR), etc. In addition, the technical solution of the embodiments of the present application can be applied to the future-oriented communication technology. In addition, the technical solution of the embodiments of the present application can be applied to the future-oriented communication technology.

The following description with reference to the accompanying drawings is provided to assist in a comprehensive understanding of various embodiments of the present disclosure as defined by the claims and their equivalents. The description includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings thereof, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It should be understood that the singular forms “a,” “an,” and “the” include plural referents unless the context clearly dictates otherwise. Thus, for example, reference to “a part surface” includes reference to one or more of such surfaces.

The terms “include,” or “may include” refer to the existence of a corresponding function, operation, or component used in various embodiments of the present disclosure, and does not exclude the existence of one or more additional functions, operations or features. Further, the terms “including” or “having” may be construed to denote certain characteristics, numbers, steps, operations, constituent elements, components, or combinations thereof, but should not be construed to exclude the possibility of the existence of one or more other characteristics, numbers, steps, operations, constituent elements, components, or combinations thereof.

The term “or” used in various embodiments of the present disclosure includes any of the listed terms and all combinations thereof. For example, the expression “A or B” may include A, may include B, or may include both A and B.

Unless otherwise defined, all terms (including technical or scientific terms) used herein have the same meaning as commonly understood by those skilled in the art. General terms, such as those defined in commonly used dictionaries, should be interpreted as having a meaning that is consistent with their meaning in the context of the relevant art and should not be interpreted in an idealized or overly formal sense unless expressly so defined herein.

FIGS. 1 to 11 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrates a system architecture 100 of system architecture evolution (SAE) according to embodiments of the present disclosure. A user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

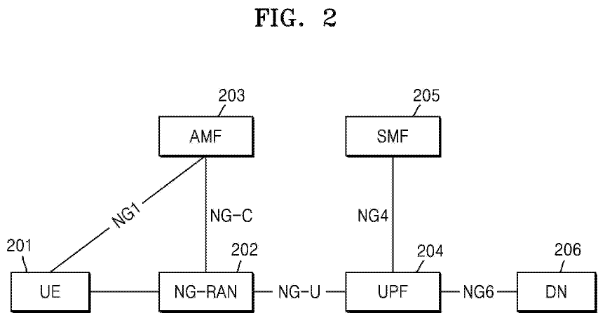

FIG. 2 illustrates a system architecture 200 according to various embodiments of the present disclosure. Other embodiments of the system architecture 200 can be used without departing from the scope of the present disclosure.

A user equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

How to support the mobility robustness in dual connectivity is a problem that needs to be solved at present. In addition, for successful handover or dual connection process, there will be possible failures in the process, and how to avoid potential failures is also a problem to be solved.

In order to improve the reliability of PSCell (PSCell, SpCell of a secondary cell group (primary cell of a master or secondary cell group),) change, conditional PSCell change (CPC) is defined in the prior art. The CPC in the prior art is internal to a secondary node (SN). In the prior art, conditional PSCell addition (CPA) and a CPC process between the SNs are further defined. Improper configuration or triggering of the CPA or CPC process may also cause the secondary cell group (SCG) failure or potential failures. Therefore, how to identify the type of failure or potential failures for reasonable optimization is a problem that needs to be solved at present.

For successful PSCell change or secondary node change, there are failures or potential failure risks in the process of PSCell change. In order to solve these potential failure risks, it is unclear how the network node configures UE, how the UE reports, which network node the UE reports to, and how the network node that receives the UE report transmits the report to a node needing to execute optimization. Meanwhile, two or three of a master base station, a source secondary node, a target secondary node and a node receiving a successful PSCell report may also be base stations supporting different radio access technologies. How to forward and identify the successful PSCell report is also a problem needing to be solved.

A method supporting self-configuration and self-optimization of the present disclosure can correctly identify the potential problems in successful handover process or the successful PSCell change process in a dual connection state, and the successful PSCell report can be transmitted to a correct node for reasonable optimization, thus avoiding the occurrence of potential problems in the future, ensuring service continuity, and reducing the labour cost of operators.

In an embodiment of the present disclosure, a configuration of a T310, a T312, and/or a T304 may be optimized via a successful PSCell report process, thereby avoiding potential failures in the PSCell change or handover process.

In an embodiment of the present disclosure, a configuration of the PSCell change or handover may also be optimized via a successful PSCell report process, thereby avoiding potential failures in the PSCell change or handover process.

In the method of the present disclosure, a threshold value of a corresponding timer in the successful PSCell report configuration can be determined by a network node that configures the timer, the successful PSCell report configuration can also be determined by a network node who triggered the PSCell change or addition or handover.

As understood by those skilled in the art, the “timer” referred to in this disclosure may also be referred to as a timer or clock, and these terms can be used interchangeably in the present disclosure.

Exemplary embodiments of the present disclosure are further described below in conjunction with the accompanying drawings.

The text and drawings are provided as examples only to help understand the present disclosure. They should not be construed to limit the scope of the present disclosure in any way. Although some embodiments and examples have been provided, it is apparent to those skilled in the art that based on the disclosure herein, changes may be made to the illustrated embodiments and examples without departing from the scope of the present disclosure.

It should be noted that the method of the present disclosure is applicable to PSCell change processes, including a normal PSCell change process and a CPC or CPA process. For the CPC and CPA processes, the CPC is taken as an example for description in the present disclosure. The problems and methods described in the present disclosure are equally applicable to the CPA process. When the method is applicable to the CPA, it only needs to replace CPC with CPA. Likewise, the method described in the present disclosure is also equally applicable to a conditional PSCell addition or change (CPAC) process, and CPAC is used instead of CPC when applicable.

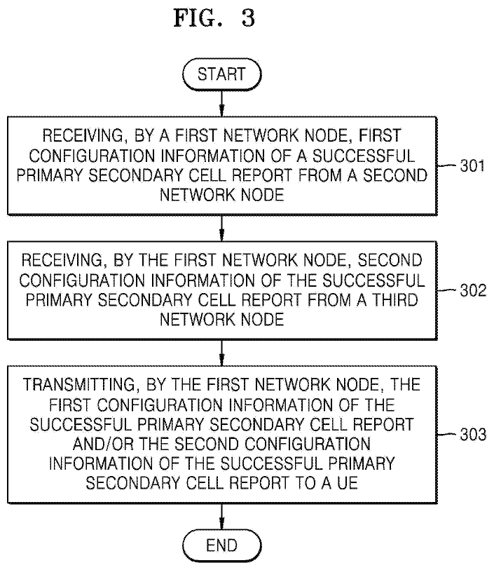

An example of a method I supporting self-configuration and self-optimization according to the present disclosure is as shown in FIG. 3. The method may be used for how to configure a successful PSCell report of UE in the secondary node change process. The method may also be used for how to configure a successful PSCell report of UE in the SN change process during a handover process. In the method, a first network node may be a master node or a source master node, a second network node may be a source secondary node or a target secondary node or a target master node, and the third network node can be a target secondary node or a source secondary node or a target master node. The method includes the following steps.

In one example of Step 301, the first network node receives first configuration information of a successful PSCell report from the second network node.

Corresponding to a case that the second network node is a target secondary node, the first configuration information of the successful PSCell report includes a threshold value of a timer T304. The first network node may also receive a value of the T304 from the target secondary node.

Corresponding to a case that the second network node is a source secondary node, the first configuration information of the successful PSCell report includes a threshold value of a timer T310 and/or a threshold value of a timer T312. The first network node may also receive a value of the T310 and/or a value of the T312 from the source secondary node.

Corresponding to a case that the second network node is a target master base station, the target master base station may also obtain the first configuration information of the PSCell report from a target secondary base station. The first configuration information of the successful PSCell report includes a threshold value of a timer T304. The first network node may also receive the value of the T304 configured by the target secondary base station from the target master base station.

The threshold value is a threshold percentage of the timer.

In one example of Step 302, the first network node receives second configuration information of the successful PSCell report from a third network node.

Corresponding to a case that the third network node is a source secondary node, the second configuration information of the successful PSCell report includes a threshold value of a timer T310 and/or a threshold value of a timer T312. The first network node may also receive a value of the T310 and/or a value of the T312 from the source secondary node.

Corresponding to a case that the third network node is a target secondary node, the second configuration information of the successful PSCell report includes a threshold value of a timer T304. The threshold value is a threshold percentage of the timer. The first network node may also receive a value of the T304 from the target secondary node.

Corresponding to a case that the second network node is a target master base station, the target master base station may also obtain the first configuration information of the PSCell report from the target secondary base station. The first configuration information of the successful PSCell report includes a threshold value of a timer T304. The first network node may also receive a value of the T304 configured by the target secondary base from the target master base station.

In one example of Step 303, the first network node transmits the first configuration information of the successful PSCell report and/or the second configuration information of the successful PSCell report to UE. The first configuration information of the PSCell report may be received by the first network node from the second network node or the third network node or may be configured by the first network node. The second configuration information of the PSCell report may be received by the first network node from the second network node or the third network node or may be configured by the first network node. Corresponding to a method that the first network node configures the first configuration information of the successful PSCell report and/or the second configuration information of the successful PSCell report, the first network node may also transmit the configured first configuration information to the source secondary node or the target secondary node, and the first network node may also transmit the configured second configuration information to the source secondary node or the target secondary node.

Corresponding to the SN addition process, Step 301 or Step 302 above may be unnecessary or skipped.

So far, the method I supporting self-configuration and self-optimization of the present disclosure is completed. With such a method, potential failures can be correctly identified in the case of successful PSCell change or addition or successful SN change or addition in the process of SN change or SN addition during handover, to perform reasonable optimization to avoid occurrence of failures, guarantee service continuity and reduce labour costs of operators.

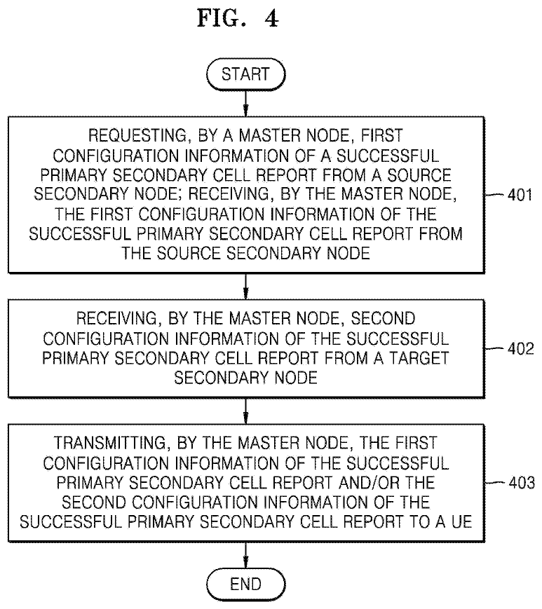

An example of a method II supporting self-configuration and self-optimization according to the present disclosure is as shown in FIG. 4. The method is used for how to configure a successful PSCell report of UE in the secondary node change or addition process. The method may be used in the conditional secondary node change or addition process triggered by MN. The method includes the following steps:

In one example of Step 401, a master node requests first configuration information of a successful PSCell report from a source secondary node. The master node transmits a message to the source secondary node to request the first configuration information of the PSCell report. The first configuration information includes a threshold value of a timer T310 and/or a threshold value of a timer T312. The threshold value is a threshold percentage of the timer. The message may be an SN modification request message or other messages. The message includes indication information requesting the first configuration information of the PSCell report or includes indication information requesting the threshold value of the T310 and the threshold value of the T312, or includes indication information requesting the threshold value of the T310 and/or indication information requesting the threshold value of the T312. The master node may also request a value of the T310 and/or a value of the T312 from the source secondary node.

The master node receives the first configuration information of the successful PSCell report from the source secondary node. The master node receives the first configuration information of the successful PSCell report from the source secondary node via a secondary node request acknowledgment message or other messages. The first configuration information includes the threshold value of the timer T310 and/or the threshold value of the timer T312. The master node may also receive the value of the T310 and/or the value of the T312 from the source secondary node.

In one example of Step 402, the master node receives second configuration information of the successful PSCell report from a target secondary node. The second configuration information of the successful PSCell report includes a threshold value of a timer T304. The threshold value is a threshold percentage of the timer. The master node may also receive a value of the T304 from the source secondary node.

In one example of Step 403, the master node transmits the first configuration information of the successful PSCell report and/or the second configuration information of the successful PSCell report to UE. The first configuration information of the PSCell report may be received by the master node from the source SN or may be configured by the master node. The second configuration information of the PSCell report may be received by the master node from the target SN or may be configured by the master node. Corresponding to a method that the master node configures the first configuration information of the successful PSCell report and/or the second configuration information of the successful PSCell report, the master node may also transmit the configured first configuration information to the source secondary node or the target secondary node, and the master node may also transmit the configured second configuration information to the source secondary node or the target secondary node.

Corresponding to the SN addition process, Steps 401 or 402 may be unnecessary or skipped.

So far, the method II supporting self-configuration and self-optimization of the present disclosure is completed. With such a method, potential failures can be correctly identified in the case of successful PSCell change in a dual connection state, to perform reasonable optimization to avoid occurrence of failures, guarantee service continuity and reduce labour costs of operators.

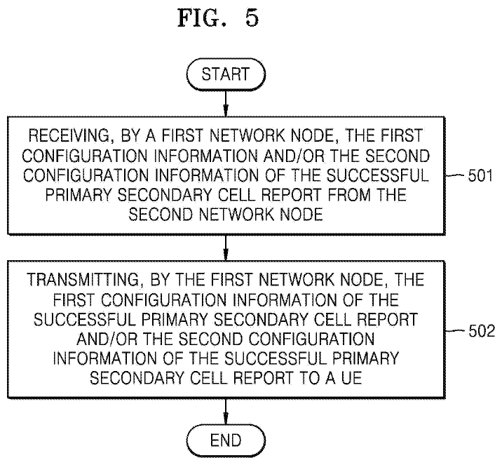

An example of a method III supporting self-configuration and self-optimization according to the present disclosure is as shown in FIG. 5. The method is used for how to configure a successful PSCell report of UE in the PSCell change process. In such a method, a first network node may be a master node, and a second network node may be a secondary node. The method may be used for the processes of PSCell change inside the secondary node, or intra-SN conditional PSCell change, or PSCell addition or conditional PSCell addition inside the secondary node. The method includes the following steps:

In one example of Step 501, the first network node receives first configuration information of a successful PSCell report and/or second configuration information of a successful PSCell report from the second network node. The first configuration information of the successful PSCell report includes a threshold value of a timer T304, and the second configuration information of the successful PSCell report includes a threshold value of a timer T310 and/or a threshold value of a timer T312. The threshold value is a threshold percentage of the timer. Corresponding to the process of PSCell addition or conditional PSCell addition, the first network node receives the first configuration information of the successful PSCell report from the second network node. The first network node may also receive a value of the T304, a value of the T310 and/or a value of the T312 from the second network node.

For the process that the PSCell change inside the secondary node or the conditional PSCell change inside the secondary node is implemented through SRB3 (MN does not involve), this step does not need to be executed, and Step 502 is directly executed.

In one example of Step 502, the first network node transmits the first configuration information of the successful PSCell report and/or the second configuration information of the successful PSCell report to UE. Corresponding to the process of PSCell addition or conditional PSCell addition, the first network node transmits the first configuration information of the successful PSCell report to the UE. Corresponding to a method that the first network node configures the first configuration information of the successful PSCell report and/or the second configuration information of the successful PSCell report, the first network node may also transmit the configured first configuration information to a source secondary node or a target secondary node, and the first network node may also transmit the configured second configuration information to the source secondary node or the target secondary node.

So far, the method III supporting self-configuration and self-optimization of the present disclosure is completed. With such a method, potential failures can be correctly identified in the case of successful PSCell change or addition, to perform reasonable optimization to avoid occurrence of failures, guarantee service continuity and reduce labour costs of operators.

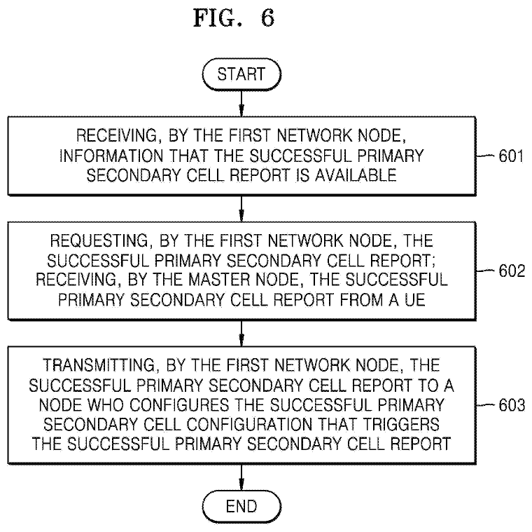

An example of a method IV supporting self-configuration and self-optimization according to the present disclosure is as shown in FIG. 6. The method is used for a method for transmitting a successful PSCell report. In the method, a first network node may be a master node, a source secondary node, a target secondary node, or other base stations accessed by UE. The method includes the following steps:

In one example of Step 601, the first network node receives information that a successful PSCell report is available. The first network node may receive the information that the successful PSCell report is available via an RRC reconfiguration complete message or other messages.

In one example of Step 602, the first network node requests a successful PSCell report of UE. The first network node may request the successful PSCell report via a UE information request message or other messages. The first network node receives the successful PSCell report from the UE. The UE may transmit the information of the successful PSCell report to the first network node via a UE information response message or other RRC messages.

The successful PSCell report includes one or more of the following information:
Time from receiving the successful PSCell report configuration to transmitting the successful PSCell report;
Time from saving the successful PSCell report by the UE to transmitting the successful PSCell report;
Time from executing PSCell change or addition to transmitting a PSCell report;
Cell information of a primary cell at the time of PSCell change or addition, wherein the cell information of the primary cell includes a cell identifier of the primary cell, and/or an identifier of a tracking area where the primary cell is located; the PSCell change or addition corresponds to the PSCell change or addition corresponding to the successful PSCell report;
Cell information of a source PSCell, wherein the cell information includes a cell identifier of the cell and/or an identifier of a tracking area where the cell belongs;
A cell identifier of a target PSCell, wherein the cell information includes a cell identifier of the cell and/or an identifier of a tracking area where the cell belongs;
A C-RNTI (Cell-Radio Network Temporary Identifier) allocated by the source PSCell;
A C-RNTI allocated by the target PSCell;
A C-RNTI allocated by the PCell;
UE location information;
Causes for successful PSCell report, wherein the causes for the successful PSCell report in the message transmitted by the UE may also include a cause for a timer T316;
Common random access information;
For CPC or CPA, the successful PSCell report transmitted by the UE may also include time from CPC or CPA configuration to CPC or CPA execution;
Whether the PSCell change is initiated by MN or SN;
A measurement result of the UE;
A threshold value of T310, a threshold value of T312 and/or a threshold value of T304 which are configured by the MN. When the MN configures the threshold value of the T310, the threshold value of the T312 and/or the threshold value of the T304, the successful PSCell report includes the threshold value of the T310, the threshold value of the T312 and/or the threshold value of the T304;
Mobility information of the UE in a PCell of the MN, mobility information of the UE in the source PSCell, and/or mobility information of the UE in the target PSCell;
C-RNTI allocated by a source PCell; and/or
C-RNTI allocated by a target PCell.

The UE receives the information of the PSCell change initiated by the MN or SN from an RRC reconfiguration message.

The UE receives the mobility information of the UE in the PCell of the MN, the mobility information of the UE in the source PSCell, and/or the mobility information of the UE in the target PSCell from the RRC reconfiguration message. The mobility information of the UE in the PCell of the MN is used for the MN to find out context information associated with the PCell change and is used to optimize subsequent PSCell change. The mobility information of the UE in the source PSCell is used for a source SN to find out the context information associated with the PSCell change and is used to optimize the subsequent PSCell change. The mobility information of the UE in the target PSCell is used for a target SN to find out the context information associated with the PSCell change and is used to optimize the subsequent PSCell change. The context information associated with the PCell change may also be referred to as the UE context information.

The successful PSCell report may be encoded in an RRC format supported by the first network node, or in an RRC format supported by a network node that triggers the successful PSCell report. For example, if the PSCell report is caused due to the T310 and/or T312, the successful PSCell report is encoded in an RRC format supported by the source SN, and if the PSCell report is caused due to the T304, the successful PSCell report is encoded in an RRC format supported by the target SN. The successful PSCell report may also be encoded in an RRC format supported by a node triggering the PSCell change. For example, if the PSCell change or addition process is triggered by the MN, the successful PSCell report is encoded in an RRC format of the radio access technology supported by the MN, and if the PSCell change process is triggered by the source SN, the successful PSCell report is encoded in an RRC format of the radio access technology supported by the source SN.

The RRC format of the successful PSCell report may also be determined as follows:
The PSCell report is caused due to the T310 and/or the T312, if the PSCell change or addition process is triggered by the MN, the successful PSCell change process is encoded in an RRC format of the radio access technology supported by the MN, and if the PSCell change process is triggered by the source SN, the successful PSCell change process is encoded in an RRC format of the radio access technology supported by the source SN; and/or
If the PSCell report is caused due to the T304, the successful PSCell change process is encoded in an RRC format of the radio access technology supported by the target SN.

If the successful PSCell report is not encoded in the RRC format supported by the first network node, the RRC message for transmitting the successful PSCell report also includes cell information of a cell PSCell who configures the successful PSCell configuration that triggers the successful PSCell report. For example, if the PSCell report is caused due to the T310 and/or the T312, the RRC message includes the cell information of the source PSCell. If the PSCell report is caused due to the T304, the RRC message includes the cell information of the target PSCell. The cell information includes a cell identifier and/or a tracking area identifier. The cell information is included outside the successful PSCell report.

If the successful PSCell report is not encoded in the RRC format supported by the first network node, the RRC message for transmitting the successful PSCell report also includes cell information of a cell triggering the PSCell change or addition. For example, if the PSCell change or addition is triggered by the MN, the RRC message includes the cell information of the source PCell. If the PSCell change is triggered by the source SN, the RRC message includes the cell information of the source PSCell. The cell information is included outside the successful PSCell report.

If the successful PSCell report is not encoded in the RRC format supported by the first network node, and the PSCell report is caused due to the T304, the RRC message includes the cell information of the target PSCell. If the PSCell report is caused due to the T310 and/or the T312, the RRC message includes the cell information of a cell that triggers the PSCell change or addition. For example, if the PSCell change and addition is triggered by the MN, the RRC message includes the cell information of the PCell. If the PSCell change is triggered by the source SN, the RRC message includes the cell information of the source PSCell. The cell information includes a cell identifier and/or a tracking area identifier. The cell information is included outside the successful PSCell report.

In one example of Step 603, the first network node transmits the successful PSCell report to a node who configures the successful PSCell configuration that triggers the successful PSCell report, or a node that triggers the PSCell change or addition, or a node required to execute cause analysis, or a node needing to be optimized.

If the successful PSCell report is caused by a successful PSCell report configuration configured by the source SN, the first network node transmits the successful PSCell report to the source SN. For example, if the cause for the PSCell report is caused by the T310 and/or the T312, the first network node transmits the successful PSCell report to the source SN. The message transmitted to the source SN includes the mobility information of the UE in the source PSCell. The message transmitted to the source SN includes the C-RNTI of the UE in the source PSCell.

If the cause for the PSCell report is caused by the T310 and/or the T312, and the PSCell change or addition is triggered by the MN, the first network node transmits the successful PSCell report to the MN, and the message transmitted to the MN includes the mobility information of the UE in the PCell of the MN. The message transmitted to the MN includes the C-RNTI of the UE in the PCell of the MN, and/or the C-RNTI of the UE in the source PSCell. For the PSCell change triggered by the source SN, the first network node can also transmit the successful PSCell report to the source SN. The message transmitted to the source SN includes the mobility information of the UE in the source PSCell. The message transmitted to the source SN includes the C-RNTI of the UE in the source PSCell.

If the successful PSCell report is caused by a successful PSCell change configuration configured by the target SN, the first network node transmits the successful PSCell report to the target SN. For example, if the cause for the PSCell report is caused by the T304, the first network node transmits the successful PSCell report to the target SN. The message transmitted to the target SN includes the mobility information of the UE in the target PSCell. The message transmitted to the source SN includes the C-RNTI of the UE in the target PSCell.

If the PSCell change or addition is triggered by the MN, the first network node may also transmit the successful PSCell report to the MN, and the message transmitted to the MN includes the mobility information of the UE in the PCell of the MN. The message transmitted to the MN includes the C-RNTI of the UE in the PCell of the MN. For the PSCell change triggered by the source SN, the first network node may also transmit the successful PSCell report to the source SN. The message transmitted to the source SN includes the mobility information of the UE in the source PSCell. The message transmitted to the source SN includes the C-RNTI of the UE in the source PSCell.

If the successful PSCell report is not encoded in an RRC format supported by a node who configures the successful PSCell configuration that triggers the successful PSCell report, the first network node converts the successful PSCell report encoded in the RRC format of the first network node into an inter-node message encoded in an RRC format supported by a node who configures the successful PSCell configuration that triggers a successful handover report or into an information element (e.g., XnAP information element) of an inter-base station message, and then transmits the converted inter-node message or the information element to the node who configures the successful PSCell configuration that triggers the successful PSCell report. The inter-node message may also be referred to as an inter-node RRC message.

If the first network node is not the master node at the time of successful PSCell change, there are two ways for the first network node to transmit the successful PSCell report to the node who configures the successful PSCell configuration that triggers the successful handover report, or the node that triggers the PSCell change or addition.

In one embodiment of Method I, the first network node transmits the successful PSCell report to a master node serving the UE at the time of successful PSCell change, and the master node further determines to transmit the successful PSCell report to a source SN or a target SN. If the successful PSCell report is caused by a successful PSCell report configuration configured by the source SN, the first network node transmits the successful PSCell report to the source SN. If the successful PSCell report is caused by a successful PSCell report configuration configured by the target SN, the first network node transmits the successful PSCell report to the target SN. If the successful PSCell report is caused by a successful PSCell report configuration configured by a MN, the MN does not need to transmit the successful PSCell report to the source SN or target SN.

In one embodiment of Method II, if the successful PSCell report is caused by the configuration of the source SN or the target SN, the first network node directly transmits the successful PSCell report to the source SN or the target SN. The first network node determines to transmit the successful PSCell report to the source SN or the target SN according to the cause of a successful handover report. If the successful PSCell report is caused by a successful PSCell change configuration configured by the source SN, the first network node transmits the successful PSCell report to the source SN. If the successful PSCell report is caused by a successful PSCell change configuration configured by the target SN, the first network node transmits the successful PSCell report to the target SN. The first network node may transmit the successful PSCell report to a node where the corresponding cell is located according to the cell information in the received RRC message.

If the first network node is a target secondary node of the successful PSCell change, and the cause for the successful PSCell report is caused by the configuration of the source PSCell, the first network node transmits the successful PSCell report to the source SN. The first node network may directly transmit the successful PSCell report to the source SN or transmit the successful PSCell report to the source SN via the MN. The first network node transmits the successful PSCell report to the MN according to an identifier of a primary cell in the successful PSCell report, and the MN transmits a successful handover report to the source SN.

If the first network node is a source secondary node of the successful PSCell change, and the cause for the successful PSCell report is caused by the configuration of the target PSCell, the first network node transmits the successful PSCell report to the target SN. The first network node may directly transmit the successful PSCell report to the target SN or transmit the successful PSCell report to the target SN via the MN. The first network node transmits the successful PSCell report to the MN according to an identifier of a primary cell in the successful PSCell report, and the MN transmits a successful handover report to the target SN.

If the first network node is a source secondary node or a target secondary node of successful PSCell change, and the cause for the successful PSCell report is caused by the configuration of the MN, the first network node transmits the successful PSCell report to the MN. The first network node transmits the successful PSCell report to the MN according to an identifier of a primary cell in the successful PSCell report.

The message transmitted by the first network node to the source SN or the target SN or the MN includes a UE identifier, which may be the C-RNTI of the UE in the target PSCell, the C-RNTI of the UE in the source PSCell, the C-RNTI of the UE in the PCell, the UE access layer (AP) identifier of the UE in the first network node, the UE AP ID of the UE in the master node, the UE AP ID of the UE in the source SN, and/or the UE AP ID of the UE in the target SN.

The node who configures the successful PSCell configuration that triggers the successful PSCell report, the node triggers the PSCell change, or addition is to optimize the subsequent PSCell change, to avoid potential failures.

So far, the method IV supporting self-configuration and self-optimization of the present disclosure is completed. With such a method, the transmitting of the successful PSCell report can be supported to correctly identify causes for the potential failures, to perform reasonable optimization to avoid occurrence of failures, ensure service continuity and reduce the labour costs of operators.

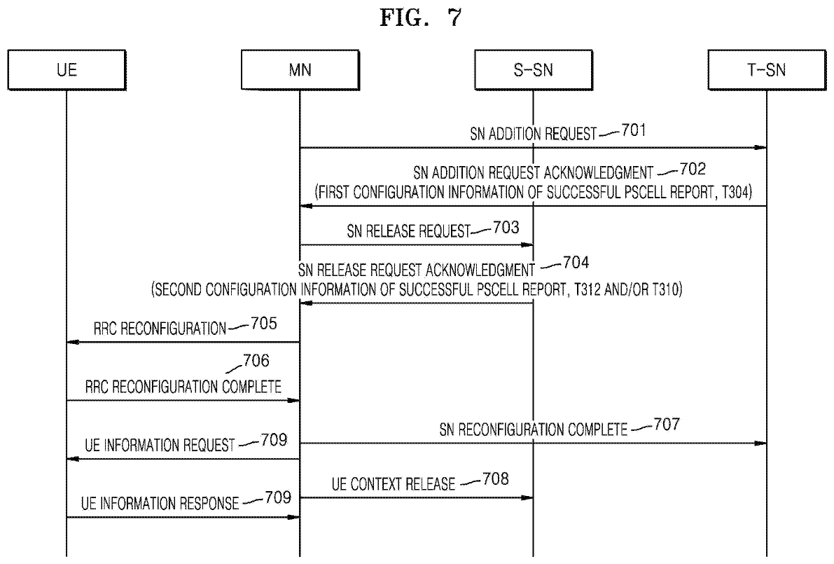

An example of an embodiment I supporting self-configuration and self-optimization in accordance with the present disclosure is as shown in FIG. 7. Detailed description of steps unrelated to the present disclosure is omitted here. The method includes the following steps as shown in examples.

In one example of Step 701, a MN transmits an SN addition request message to a target SN.

In one example of Step 702, the target SN transmits a SN addition request acknowledgement message to the MN. The message includes first configuration information of a successful PSCell report. The first configuration information of the successful PSCell report includes a threshold value of a T304. The message may also include a value of the T304. The message also includes mobility information of UE in a target PSCell. The message also includes a C-RNTI of the UE in the target PSCell.

In one example of Step 703, the MN transmits an SN release request message to a source SN. The message includes the mobility information of the UE in the target PSCell. The message also includes the C-RNTI of the UE in the target PSCell.

In one example of Step 704, the source SN transmits an SN release request acknowledgement message to the MN. The message includes second configuration information of the successful PSCell report. The second configuration information of the successful PSCell report includes a threshold value of a T310 and/or a threshold value of a T312. The message may also include a value of the T310 and/or a value of the T312. The message may include value of the T310 and/or the value of the T312 configured by the source SN. The message also includes mobility information of the UE in a source PSCell. The message also includes a C-RNTI of the UE in the source PSCell.

In one example of Step 705, the MN transmits an RRC reconfiguration message to the UE. The message includes the first configuration information of the successful PSCell report and/or the second configuration information of the successful PSCell report. The first configuration information of the successful PSCell report and/or the second configuration information of the successful PSCell report may be received from the target SN and the source SN respectively or configured by the MN. Corresponding to a case that the second configuration information of the successful PSCell report is configured by the MN, the second configuration information of the successful PSCell report may be configured by the MN with reference to the value of the T310 and/or the value of the T312 received from the source SN. Corresponding to a case that the first configuration information of the successful PSCell report is configured by the MN, the first configuration information of the successful PSCell report may be configured by the MN with reference to the value of the T304 received from the target SN.

The message also includes the information of whether the PSCell change is initiated by the MN or SN.

The message further includes mobility information of the UE in the PCell of the MN, the mobility information of the UE in the source PSCell, and/or the mobility information of the UE in the target PSCell as shown in following examples.

In one example of Step 706, the UE transmits an RRC reconfiguration complete message to the MN. The message includes information that the successful PSCell report is available.

In one example of Step 707, the MN transmits a SN reconfiguration complete message to the target SN. The message further includes the mobility information of the UE in the PCell of the MN, and/or the mobility information of the UE in the source PSCell. The message further includes a C-RNTI of the UE in the PCell of the MN and/or the C-RNTI of the UE in the source PSCell.

In one example of Step 708, the MN transmits a UE context release message to the source SN.

In one example of Step 709, the MN transmits a UE information request message to the UE to request the UE to report the successful PSCell report.

The UE transmits the successful PSCell report to the MN. The content of the successful PSCell report is the same as that in Step 602 and will not be repeated in detail here.

There is no absolute order of sequence of Step 709, Step 707, and Step 708. Step 709 may be executed first followed by Step 707 and Step 708, or Steps 707 and 708 may be executed before Step 709, or Step 707 may be executed first, then Step 709 may be executed and then Step 708 may be executed.

The MN determines whether the successful PSCell report is caused by the configuration of the MN, the configuration of the source SN, or the configuration of the target SN. If the successful PSCell report is caused by the configuration of the target SN, the MN transmits the successful PSCell report to the target SN. If the successful PSCell report is caused by the configuration of the source SN, the MN transmits the successful PSCell report to the source SN. If the successful PSCell report is caused by the MN, the MN executes the corresponding optimization. The message transmitted by the MN to the source SN or the target SN includes the successful PSCell report. The message transmitted by the MN to the source SN or the target SN also includes the information in Step 603, which will not be described in detail here.

The MN transmits information of the successful PSCell report to the source SN or the target SN via an access and mobility indication message or a newly defined message. The MN may also transmit the successful PSCell report to the target SN via a SN reconfiguration complete message. The MN may also transmit the successful PSCell report to the source SN via a UE context release message.

If a fourth network node (other than the MN, the source SN, the target SN) receives the information that the successful PSCell report is available and requests the successful PSCell report from the UE, the following methods are used for transmitting the successful PSCell report to a node that configures the successful PSCell report or a node that triggers a PSCell change or a node needs to perform cause analysis or a node needs to perform optimization:

In one example of Method I, if the successful PSCell report is caused by the configuration of the source SN or MN, the fourth network node transmits the successful PSCell report to the MN via an inter-base station interface message or via a core network. The message includes the mobility information of the UE in the PCell of the MN and/or mobility information of the UE in the source PSCell. The message includes the C-RNTI of the UE in the PCell of the MN and/or a C-RNTI of the UE in the source PSCell. If the successful PSCell report is caused by the configuration of the source SN, the MN transmits the successful PSCell report to the source SN. The message includes the mobility information of the UE in the source PSCell. The message includes the C-RNTI of the UE in the source PSCell.

If the successful PSCell report is caused by the configuration of the target SN, the fourth network node transmits the successful PSCell report to the target SN via an inter-base station interface message or via a core network. The message includes the mobility information of the UE in the target PSCell. The message includes the C-RNTI of the UE in the target PSCell.

In one embodiment of Method II, if the successful PSCell report is caused by the configuration of the source SN, the fourth network node transmits the successful PSCell report to the source SN via an inter-base station interface message or via a core network. The message includes the mobility information of the UE in the source PSCell. The message includes the C-RNTI of the UE in the source PSCell.

If the successful PSCell report is caused by the configuration of the MN, the fourth network node transmits the successful PSCell report to the MN via an inter-base station interface message or via a core network. The message includes the mobility information of the UE in the PCell of the MN. The message includes the C-RNTI of the UE in the PCell of the MN.

If the successful PSCell report is caused by the configuration of the target SN, the fourth network node transmits the successful PSCell report to the target SN via an inter-base station interface message or via a core network. The message includes the mobility information of the UE in the target PSCell. The message includes the C-RNTI of the UE in the target PSCell.

In one embodiment of Method III, if the successful PSCell report is caused by the configuration of the source SN, the fourth network node transmits the successful PSCell report to the source SN via an inter-base station interface message or via a core network. The message includes the mobility information of the UE in the source PSCell. The message includes the C-RNTI of the UE in the source PSCell.

If the successful PSCell report is caused by the configuration of the target SN or MN, the fourth network node transmits the successful PSCell report to the MN via an inter-base station interface message or via a core network. The message includes the mobility information of the UE in the PCell of the MN and/or the mobility information of the UE in the target PSCell. The message includes the C-RNTI of the UE in the PCell of the MN and/or the C-RNTI of the UE in the target PSCell. If the successful PSCell report is caused by the configuration of the target SN, the MN transmits the successful PSCell report to the target SN. The message includes the mobility information of the UE in the target PSCell. The message includes the C-RNTI of the UE in the target PSCell.

In one embodiment of Method IV, if the successful PSCell report is caused by the configuration of the source SN or MN, the fourth network node transmits the successful PSCell report to the MN via an inter-base station interface message or via a core network. The message includes the mobility information of the UE in the PCell of the MN and/or the mobility information of the UE in the source PSCell. The message includes the C-RNTI of the UE in the PCell of the MN and/or the C-RNTI of the UE in the source PSCell. If the successful PSCell report is caused by the configuration of the source SN, the MN transmits the successful PSCell report to the source SN. The message includes the mobility information of the UE in the source PSCell. The message includes the C-RNTI of the UE in the source PSCell.

If the successful PSCell report is caused by the configuration of the target SN or MN, the fourth network node transmits the successful PSCell report to the MN via an inter-base station interface message or via a core network. The message includes the mobility information of the UE in the PCell of the MN and/or the mobility information of the UE in the target PSCell. The message includes the C-RNTI of the UE in the PCell of the MN and/or the C-RNTI of the UE in the target PSCell. If the successful PSCell report is caused by the configuration of the target SN, the MN transmits the successful PSCell report to the target SN. The message includes the mobility information of the UE in the target PSCell. The message includes the C-RNTI of the UE in the target PSCell.

If the target SN receives the successful PSCell report from the UE, and the successful PSCell report is caused by the configuration of the source SN, the target SN may directly transmit the successful PSCell report to the source SN via an inter-base station interface message or via a core network. The message further includes the mobility information of the UE in the source PSCell, and/or the C-RNTI of the UE in the source PSCell. Or the target SN transmits the successful PSCell report to the source SN via the MN, the message transmitted by the target SN to the MN includes the mobility information of the UE in the PCell of the MN, the C-RNTI of the UE in the PCell of the MN, the mobility information of the UE in the source PSCell, and/or the C-RNTI of the UE in the source PSCell. The message transmitted by the MN to the source SN includes the mobility information of the UE in the source PSCell, and/or the C-RNTI of the UE in the source PSCell.

If the source SN receives the successful PSCell report from the UE, and the successful PSCell report is caused by the configuration of the target SN, the source SN may directly transmit the successful PSCell report to the target SN via an inter-base station interface message or via a core network. The message includes the mobility information of the UE in the target PSCell. The message includes the C-RNTI of the UE in the target PSCell. Or the source SN transmits the successful PSCell report to the target SN via the MN, the message transmitted by the source SN to the MN includes the mobility information of the UE in the PCell of the MN, the C-RNTI of the UE in the PCell of the MN, the mobility information of the UE in the target PSCell, and/or the C-RNTI of the UE in the target PSCell. The message transmitted by the MN to the target SN includes the mobility information of the UE in the target PSCell, and/or the C-RNTI of the UE in the target PSCell.

So far, the embodiment I supporting self-configuration and self-optimization of the present disclosure is completed. With such a method, the successful handover report or the successful PSCell report can be supported to correctly identify causes for the potential failures, to perform reasonable optimization to avoid occurrence of failures, ensure service continuity and reduce the labour costs of operators.

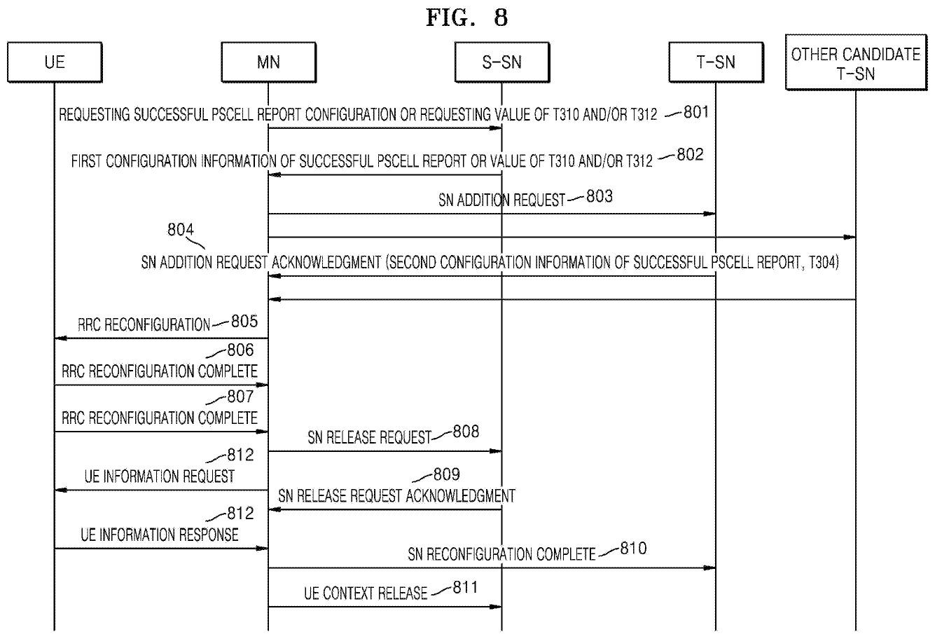

An example of an embodiment II supporting self-configuration and self-optimization in accordance with the present disclosure is as shown in FIG. 8. Detailed description of steps unrelated to the present disclosure is omitted here. The method includes the following steps as shown in following examples.

In one example of Step 801, a MN requests configuration information of a successful PSCell report from a source SN, and/or requests a value of a T310 and/or a value of a T312 from a source SN. The MN may request the configuration information of the successful PSCell report from the source SN, and/or request the value of the T310 and/or the value of the T312 from the source SN via a SN modification request message or other messages. The configuration information of the PSCell report includes a threshold value of the T310 and/or a threshold value of the T312. The configuration information here may also be the first configuration information which is the same as the first configuration information described in Step 802.

In one example of Step 802, the source SN transmits the first configuration information of the successful PSCell report and/or the value of the T310 and/or the value of the T312 to the MN. The source SN may transmit the first configuration information of the PSCell report and/or the value of the T310 and/or T312 to the MN via a SN modification request acknowledgment message or other messages. The first configuration information of the PSCell report includes a threshold value of the T310 and/or a threshold value of the T312. The message includes mobility information of UE in a source PSCell.

In one example of Step 803, the MN transmits an SN addition request to each candidate target SN. The message includes the mobility information of the UE in the source PSCell.

In one example of Step 804, the candidate target SN transmits a SN addition request acknowledgement message to the MN. The message includes second configuration information of successful PSCell change. The second configuration information of the successful PSCell report includes a threshold value of a T304. The message may also include a value of the T304. The message includes mobility information of the UE in the target PSCell.

In one example of Step 805, the MN transmits an RRC reconfiguration message to the UE. The message includes the first configuration information of the successful PSCell report and/or the second configuration information of the successful PSCell report. The first configuration information of the successful PSCell report and/or the second configuration information of the successful PSCell report may be received from the source SN and the target SN, respectively, or configured by the MN. Corresponding to a case that the first configuration information of the successful PSCell report is configured by the MN, the first configuration information of the successful PSCell report may be configured by the MN with reference to the value of T310 and/or the value of T312 received from the source SN. Corresponding to a case that the second configuration information of the successful PSCell report is configured by the MN, the second configuration information of the successful PSCell report may be configured by the MN with reference to the value of the T304 received from the target SN.

The message also includes the information of whether the PSCell change is initiated by the MN or SN.

The message also includes mobility information of the UE in a PCell of the MN, the mobility information of the UE in the source PSCell, and/or the mobility information of the UE in the target PSCell.

In one example of Step 806, the UE transmits an RRC reconfiguration complete message to the MN. The RRC configuration completion is the execution completion of the MN reconfiguration, and the completion of the execution to the target SN is achieved by Step 807.

In one example of Step 807, the UE transmits an RRC reconfiguration complete message to the MN. The reconfiguration completion may also be referred to as the reconfiguration completion*, which means that UE successfully performs reconfiguration of the target SN. The message includes information that the successful PSCell report is available.

In one example of Step 808, the MN transmits an SN release request message to the source SN.

In one example of Step 809, the source SN transmits an SN release request acknowledgement message to the MN.

In one example of Step 810, the MN transmits a SN reconfiguration complete message to the target SN.

In one example of Step 811, the MN transmits a UE context release message to the source SN.

In one example of Step 812, the MN transmits a UE information request message to the UE to request the UE to report the successful PSCell report.

The UE transmits the successful PSCell report to the MN. The content of the successful PSCell report is the same as that in Step 602 and will not be described in detail here.

Wherein there is no absolute order of sequence of Step 812 and Step 808 as well as Step 810 and Step 811. Step 812 may be executed first followed by Step 808, Step 809, Step 810, and Step 811. Step 808, Step 809, Step 810, and Step 811 may be executed before Step 812. Or, Step 808 and Step 809 may be executed first, then Step 812, Step 810 and Step 811 are sequentially executed. Or, Step 808, Step 809 and Step 810 may be executed first, then Step 812 and Step 811 are sequentially executed.

The MN determines whether the successful PSCell report is caused by the configuration of the MN or triggered by the MN, or caused by the configuration of the source SN or triggered by the source SN, or caused by the configuration of the target SN or caused by the configuration of other candidate SNs. If the successful PSCell report is caused by the configuration of the target SN or the configuration of the other candidate SN, the MN transmits the successful PSCell report to the target SN or the other candidate SN. If the successful PSCell report is caused by the configuration of the source SN or triggered by the source SN, the MN transmits the successful PSCell report to the source SN. If the successful PSCell report is caused by the MN, the MN executes the corresponding optimization. The message transmitted by the MN to the source SN or the target SN includes the successful PSCell report, the message transmitted by the MN to the source SN or the target SN also includes the information in Step 603, which will not be describe in detail here.

The MN transmits the information of the successful PSCell report to the source SN or the target SN via an access and mobility indication message or a newly defined message. The MN may also transmit the successful PSCell report to the target SN via the SN reconfiguration complete message. The MN may also transmit the successful PSCell report to the source SN via a SN release request or the UE context release message.

If a fourth network node (other than the MN, the source SN, the target SN) receives the information that the successful PSCell change is available and requests the successful PSCell report from the UE, there are the following methods for transmitting the successful PSCell report to a node configuring the successful PSCell change, or a node triggering the PSCell change, or a node needs to perform cause analysis, or a node needs to perform optimization.

In one embodiment of Method I, if the successful PSCell report is caused by the configuration of the source SN or MN, the fourth network node transmits the successful PSCell report to the MN via an inter-base station interface message or via a core network. The message includes the mobility information of the UE in the PCell of the MN and/or the mobility information of the UE in the source PSCell. If the successful PSCell report is caused by the configuration of the source SN, the MN transmits the successful PSCell report to the source SN. The message includes the mobility information of the UE in the source PSCell.

If the successful PSCell report is caused by the configuration of the target SN, the fourth network node transmits the successful PSCell report to the target SN via an inter-base station interface message or via a core network. The message includes the mobility information of the UE in the target PSCell.

In one embodiment of Method II, if the successful PSCell report is caused by the configuration of the source SN, the fourth network node transmits the successful PSCell report to the source SN via an inter-base station interface message or via a core network. The message includes the mobility information of the UE in the source PSCell.

If the successful PSCell report is caused by the configuration of the MN, the fourth network node transmits the successful PSCell report to the MN via an inter-base station interface message or via a core network. The message includes the mobility information of the UE in the PCell of the MN.

If the successful PSCell report is caused by the configuration of the target SN, the fourth network node transmits the successful PSCell report to the target SN via an inter-base station interface message or via a core network. The message includes the mobility information of the UE in the target PSCell.

In one embodiment of Method III, if the successful PSCell report is caused by the configuration of the source SN, the fourth network node transmits the successful PSCell report to the source SN via an inter-base station interface message or via a core network. The message includes the mobility information of the UE in the source PSCell.

If the successful PSCell report is caused by the configuration of the target SN or MN, the fourth network node transmits the successful PSCell report to the MN via an inter-base station interface message or via a core network. The message includes the mobility information of the UE in the PCell of the MN and/or the mobility information of the UE in the target PSCell. If the successful PSCell report is caused by the configuration of the target SN, the MN transmits the successful PSCell report to the target SN. The message includes the mobility information of the UE in the target PSCell.

In one embodiment of Method IV, if the successful PSCell report is caused by the configuration of the source SN or MN, the fourth network node transmits the successful PSCell report to the MN via an inter-base station interface message or via a core network. The message includes the mobility information of the UE in the PCell of the MN and/or the mobility information of the UE in the source PSCell. If the successful PSCell report is caused by the configuration of the source SN, the MN transmits the successful PSCell report to the source SN. The message includes the mobility information of the UE in the source PSCell.

If the successful PSCell report is caused by the configuration of the target SN or MN, the fourth network node transmits the successful PSCell report to the MN via an inter-base station interface message or via a core network. The message includes the mobility information of the UE in the PCell of the MN and/or the mobility information of the UE in the target PSCell. If the successful PSCell report is caused by the configuration of the target SN, the MN transmits the successful PSCell report to the target SN. The message includes the mobility information of the UE in the target PSCell.

If the target SN or other candidate target SN receives the successful PSCell report from the UE, and the successful PSCell report is caused by the configuration of the source SN, the target SN or other candidate target SN may directly transmit the successful PSCell report to the source SN via an inter-base station interface message or via a core network. The message also includes the mobility information of the UE in the source PSCell. Or the target SN or other candidate target SN transmits the successful PSCell report to the source SN via the MN, the message transmitted by the target SN to the MN includes the mobility information of the UE in the PCell of the MN and/or the mobility information of the UE in the source PSCell. The message transmitted by the MN to the source SN includes the mobility information of the UE in the source PSCell.

If the source SN receives the successful PSCell report from the UE, and the successful PSCell report is caused by the configuration of the target SN or other candidate target SN, the source SN may directly transmit the successful PSCell report to the target SN or other candidate target SN via an inter-base station interface message or via a core network. The message includes the mobility information of the UE in the target PSCell. Or the source SN transmits the successful PSCell report to the target SN or other candidate target SN via the MN. The message transmitted by the source SN to the MN includes the mobility information of the UE in the PCell of the MN and/or the mobility information of the UE in the target PSCell. The message transmitted by the MN to the target SN includes the mobility information of the UE in the target PSCell.

The inter-node message in this step also includes the information described in Step 709, which will not be described in detail here.

So far, an embodiment II supporting self-configuration and self-optimization in accordance with the present disclosure is completed. With such a method, the successful handover report or the successful PSCell report may be supported to accurately identify the causes for potential failures, to perform reasonable optimization to avoid occurrence of failures, ensure service continuity and reduce the labour costs of operators.

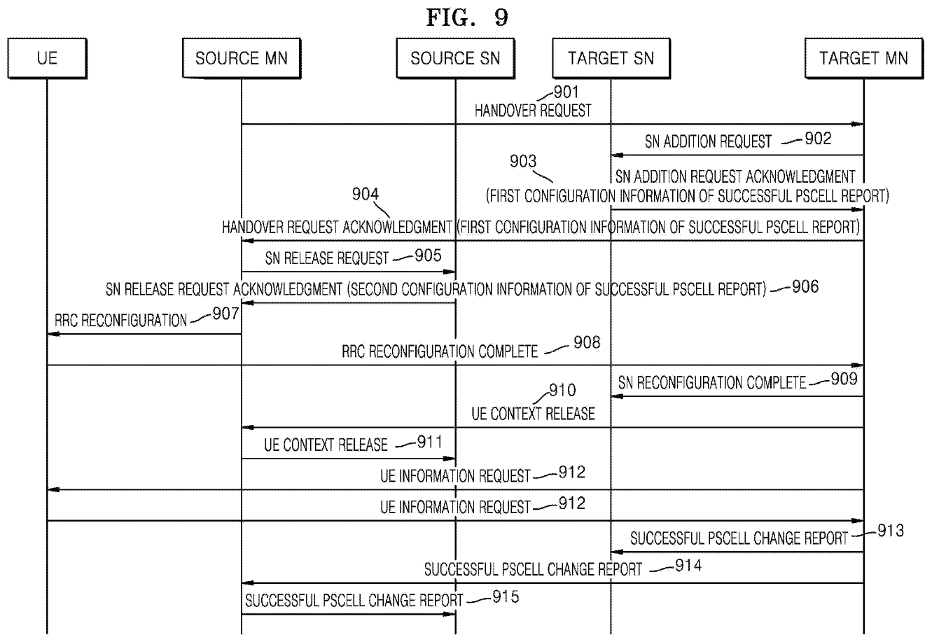

An example of an embodiment III supporting self-configuration and self-optimization in accordance with the present disclosure is as shown in FIG. 9. Detailed description of steps unrelated to the present disclosure is omitted here. The method includes the following steps:

In one example of Step 901, a source MN transmits a handover request message to a target MN. The message further includes mobility information of UE in a PCell of the source MN and/or the mobility information of the UE in the source PSCell. For the method that the source MN obtains the mobility information of the UE in the source PSCell, please refer to the description in FIG. 6 to FIG. 8. The message includes a C-RNTI of the UE in the PCell, and/or a C-RNTI of the UE in the source PSCell.

In one example of Step 902, the target MN determines to configure a dual connectivity. The target MN transmits an SN addition request message to a target SN. The message includes configuration information of a source side. The configuration information of the source side includes configuration information of the source SN. The message may also include the information received from the source MN in Step 901.

In one example of Step 903, the target SN transmits a SN addition request acknowledgement message to the target MN. The message includes first configuration information of a successful PSCell report. The first configuration information of the successful PSCell report includes a threshold value of a T304. The threshold value of the T304 is configured by the target SN. The message may also include a value of the T304. The message includes mobility information of the UE in a target PSCell, and/or a C-RNTI of the UE in the target PSCell.

In one example of Step 904, the target MN transmits a handover request acknowledgement message to the source MN. The message includes the first configuration information of the successful PSCell report. The first configuration information of the successful PSCell report includes the threshold value of the T304. The threshold value of the T304 is configured by the target SN. The message may also include a value of the T304 configured by the target SN. The handover request acknowledgement message may also include the threshold value of the T304 configured by the target MN, which is used for the UE to determine to save and report a successful handover report. The handover request acknowledgement message may also include the value of the T304 configured by the target MN. The message includes mobility information of the UE in the target MN, the mobility information of the UE in the target PSCell, a C-RNTI of the UE in a target PCell, and/or the C-RNTI of the UE in the target PSCell.

In one example of Step 905, the MN transmits an SN release request message to the source SN. The message includes the mobility information of the UE in the target MN, the mobility information of the UE in the target PSCell, the C-RNTI of the UE in the target PCell, the C-RNTI of the UE in the target PSCell, the mobility information of the UE in the source MN, and/or a C-RNTI of the UE in a source PCell.

In one example of Step 906, the source SN transmits an SN release request acknowledgement message to the MN. The message includes second configuration information of the successful PSCell report. The second configuration information of the successful PSCell report includes a threshold value of a T310 and/or a threshold value of a T312. The threshold value of the T310 and/or the threshold value of the T312 is configured by the source SN. The message may also include a value of the T310 and/or a value of the T312. The value of the T310 and/or the value of the T312 that may also be included in the message are configured by the source SN. The message includes the mobility information of the UE in the source PSCell, and/or the C-RNTI of the UE in the source PSCell.

In one example of Step 907, the MN transmits an RRC reconfiguration message to the UE. The RRC reconfiguration message includes the first configuration information of the successful PSCell report and/or the second configuration information of the successful PSCell report. The first configuration information of the successful PSCell report and/or the second configuration information of the successful PSCell report may be received from the target SN and the source SN, respectively, or configured by the MN. Corresponding to a case that the second configuration information of the successful PSCell report is configured by the MN, the second configuration information of the successful PSCell report may be configured by the MN with reference to the value of the T310 and/or the value of the T312 received from the source SN. Corresponding to a case that the first configuration information of the successful PSCell report is configured by the MN, the first configuration information of the successful PSCell report may be configured by the MN with reference to the value of T304 received from the target MN, and the value of the T304 received from the target MN is the value of the T304 configured by the target SN and received from the target MN. The RRC reconfiguration message may also include successful handover configuration information. The successful handover configuration information includes the threshold value of the T310 and/or the threshold value of the T312 configured by the source MN, and/or the threshold value of the T304 configured by the target MN.

The message further includes mobility information of the UE in a PCell of the source MN, the mobility information of the UE in the source PSCell, the mobility information of the UE in the PCell of the target MN, and/or the mobility information of the UE in the target PSCell.

In one example of Step 908, the UE transmits an RRC reconfiguration complete message to the target MN. The message includes information that the successful PSCell report is available. The message may also include information that the successful handover report is available.

In one example of Step 909, the target MN transmits a SN reconfiguration complete message to the target SN.

In one example of Step 910, the target MN transmits a UE context release message to the source MN.

In one example of Step 911, the source MN transmits the UE context release message to the source SN.

In one example of Step 912, the target MN transmits a UE information request message to the UE to request the UE to report the successful PSCell report. If the target MN receives the information that the successful handover report is available, the target MN may also request the successful handover report at the same time.

The UE transmits the successful PSCell report to the MN. The content of the successful PSCell report is the same as that in Step 602 and will not be described in detail here. In addition, the successful PSCell report may also include the mobility information of the UE in the target PCell, and/or the C-RNTI of the UE in the target PCell. If the target MN requests the successful handover report, the UE may also transmit the successful handover report to the target MN at the same time.

Wherein there is no absolute order of sequence of Step 912, Step 909, and 910. Step 912 may be executed first followed by Step 909 and Step 910. Or Step 909 and Step 910 may be executed before Step 912. Step 809 may be executed first, and then Step 912 and Step 910 are sequentially executed.

The target MN determines whether the successful PSCell report is caused by the configuration of the target MN or triggered by the target MN, caused by the configuration of the source MN or triggered by the source MN, or caused by the configuration of the source SN or triggered by the source SN, or caused by the configuration of the target SN. If the successful PSCell report is caused by the configuration of the target SN, the target MN transmits the successful PSCell report to the target SN. The message transmitted by the target MN to the target SN includes the successful PSCell report, the message transmitted by the target MN to the target SN also includes the information in Step 603, which will not be described in detail here. The message may also include the mobility information of the UE in the target PSCell, and/or the C-RNTI of the UE in the target PSCell. The target MN transmits the information of the successful PSCell report to the target SN via an access and mobility indication message or a newly defined message. The target MN may also transmit the successful PSCell report to the target SN via the SN reconfiguration complete message.

If the successful PSCell report is caused by the configuration of the source SN or triggered by the source SN, the target MN can transmit the successful PSCell report to the source SN in two methods as shown below.

In one embodiment of Method I, Step 914, the target MN transmits the successful PSCell report to the source MN, the target MN may transmit the successful PSCell report to the source MN via an access and mobility indication message or other messages, and the message may also include the information of the source PSCell, and/or the information of the target PSCell. The information of the source PSCell and the information of the target PSCell include a cell identifier of the cell and/or an identifier of a tracking area where the cell is located. The message may also include a C-RNTI allocated by the target PSCell to the UE, a C-RNTI allocated by the source PSCell to the UE, a C-RNTI allocated by the target primary cell to the UE, and/or a C-RNTI allocated by the source primary cell to the UE. The message may also include the mobility information of the UE in the source PSCell, and/or the mobility information of the UE in the source primary cell.

In one example of Step 915, the source MN transmits the successful PSCell report to the source SN. The source MN may transmit the successful PSCell report to the source SN via an access and mobility indication message or other messages, and the message may also include the information of the source PSCell, and/or the information of the target PSCell. The message may also include the C-RNTI allocated by the target PSCell to the UE, and/or the C-RNTI allocated by the source PSCell to the UE. The message may also include the mobility information of the UE in the source PSCell.

In one embodiment of Method II, the target MN directly transmits the successful PSCell report to the source SN. The target MN may transmit the successful PSCell report to the source SN via an access and mobility indication message or other messages. The message may also include the information of the source PSCell, and/or the information of the target PSCell. The message may also include the C-RNTI allocated by the target PSCell to the UE, and/or the C-RNTI allocated by the source PSCell to the UE. The message may also include the mobility information of the UE in the source PSCell.

If the successful PSCell report is caused by the target MN, the target MN performs the corresponding optimization.

If the successful PSCell report is caused by the configuration of the source MN or triggered by the source MN, in Step 914, the target MN transmits the successful PSCell report to the source MN, the target MN may transmit the successful PSCell report to the source MN via an access and mobility indication message or other messages, and the message may also include the information of the source PSCell, and/or the information of the target PSCell. The information of the source PSCell and the information of the target PSCell include a cell identifier of the cell and/or an identifier of a tracking area where the cell is located. The message may also include the C-RNTI allocated by the target PSCell to the UE, the C-RNTI allocated by the source PSCell to the UE, the C-RNTI allocated by the target primary cell to the UE, and/or the C-RNTI assigned by the source primary cell to the UE. The message includes the mobility information of the UE in the PCell of the source MN, and/or the mobility information of the UE in the source PSCell.

The target MN may also transmit the successful PSCell report to the source MN via a UE context release message. The source MN may also transmit the successful PSCell report to the source SN via the UE context release message. The message includes the mobility information of the UE in the source PSCell.

If a fifth network node (other than the source MN, or the target MN, or the source SN, or the target SN) receives the information that the successful PSCell change is available and requests the successful PSCell report from the UE, there are the following methods for transmitting the successful PSCell report to a node configuring the successful PSCell change, or a node triggering the PSCell change, or a node needs to perform cause analysis, or a node needs to perform optimization as shown in following embodiments.

In one embodiment of Method I, if the successful PSCell report is caused by the configuration of the source SN or source MN, the fifth network node transmits the successful PSCell report to the source MN via an inter-base station interface message or via a core network. The message includes the mobility information of the UE in the PCell of the source MN, and/or the mobility information of the UE in the source PSCell. If the successful PSCell report is caused by the configuration of the source SN, the source MN transmits the successful PSCell report to the source SN. The message includes the mobility information of the UE in the source PSCell.

If the successful PSCell report is caused by the configuration of the target SN or target MN, the fifth network node transmits the successful PSCell report to the target MN via an inter-base station interface message or via a core network. The message includes the mobility information of the UE in the PCell of the target MN, and/or the mobility information of the UE in the target PSCell. If the successful PSCell report is caused by the configuration of the target SN, the target MN transmits the successful PSCell report to the target SN. The message includes the mobility information of the UE in the target PSCell.

In one embodiment of Method II, if the successful PSCell report is caused by the configuration of the source SN, the fifth network node transmits the successful PSCell report to the source SN via an inter-base station interface message or via a core network. The message includes the mobility information of the UE in the source PSCell.

If the successful PSCell report is caused by the configuration of the source MN, the fifth network node transmits the successful PSCell report to the source MN via an inter-base station interface message or via a core network. The message includes the mobility information of the UE in the PCell of the source MN.

If the successful PSCell report is caused by the configuration of the target SN, the fifth network node transmits the successful PSCell report to the target SN via an inter-base station interface message or via a core network. The message includes the mobility information of the UE in the target PSCell.

If the successful PSCell report is caused by the configuration of the target MN, the fifth network node transmits the successful PSCell report to the target MN via an inter-base station interface message or via a core network. The message includes the mobility information of the UE in the PCell of the target MN.

In one embodiment of Method III, the fifth network node transmits the successful PSCell report to the target MN via an inter-base station interface message or via a core network. The message includes the mobility information of the UE in the PCell of the target MN, and/or the mobility information of the UE in the target PSCell. If the successful PSCell report is caused by the configuration of the target SN, the target MN transmits the successful PSCell report to the target SN. The message includes the mobility information of the UE in the target PSCell. If the successful PSCell report is caused by the configuration of the source SN or source MN, the target MN transmits the successful PSCell report to the source MN via an inter-base station interface message or via a core network. The message includes the mobility information of the UE in the PCell of the source MN, and/or the mobility information of the UE in the source PSCell. If the successful PSCell report is caused by the configuration of the source SN, the source MN transmits the successful PSCell report to the source SN. The message includes the mobility information of the UE in the source PSCell.

In one embodiment of Method IV, the fifth network node transmits the successful PSCell report to the source MN via an inter-base station interface message or via a core network. The message includes the mobility information of the UE in the PCell of the source MN, and/or the mobility information of the UE in the source PSCell. If the successful PSCell report is caused by the configuration of the source SN, the source MN transmits the successful PSCell report to the source SN. The message includes the mobility information of the UE in the source PSCell. If the successful PSCell report is caused by the configuration of the target SN or target MN, the source MN transmits the successful PSCell report to the target MN via an inter-base station interface message or via a core network. The message includes the mobility information of the UE in the PCell of the target MN, and/or the mobility information of the UE in the target PSCell. If the successful PSCell report is caused by the configuration of the target SN, the target MN transmits the successful PSCell report to the target SN. The message includes the mobility information of the UE in the target PSCell.

If the target SN receives the successful PSCell report from the UE, and the successful PSCell report is caused by the configuration of the source SN, the target SN may directly transmit the successful PSCell report to the source SN via an inter-base station interface message or via a core network. The message also includes the mobility information of the UE in the source PSCell. Or the target SN transmits the successful PSCell report to the source SN via the target MN. The message transmitted by the target SN to the target MN includes the mobility information of the UE in the PCell of the target MN, and/or the mobility information of the UE in the source PSCell. The message transmitted by the target MN to the source SN includes the mobility information of the UE in the source PSCell. Or the target SN transmits the successful PSCell report to the source SN via the target MN and the source MN, the message transmitted by the target SN to the target MN includes the mobility information of the UE in the PCell of the target MN, the mobility information of the UE in a source PCell, and/or the mobility information of the UE in the source PSCell. The message transmitted by the target MN to the source MN includes the mobility information of the UE in the PCell of the source MN, and/or the mobility information of the UE in the source PSCell. The message transmitted by the source MN to the source SN includes the mobility information of the UE in the source PSCell.

If the target SN receives the successful PSCell report from the UE, and the successful PSCell report is caused by the configuration of the source MN, the target SN may directly transmit the successful PSCell report to the source MN via an inter-base station interface message or via a core network. The message transmitted by the target SN to the source MN includes the mobility information of the UE in the PCell of the source MN. Or the target SN transmits the successful PSCell report to the MN via the target MN. The message transmitted by the target SN to the target MN includes the mobility information of the UE in the PCell of the target MN, and the mobility information of the UE in the source PCell. The message transmitted by the target MN to the source MN includes the mobility information of the UE in the PCell of the source MN.

If the target SN receives the successful PSCell report from the UE, and the successful PSCell report is caused by the configuration of the target MN, the target SN may transmit the successful PSCell report to the target MN. The message includes the mobility information of the UE in a target PCell.

If the source SN receives the successful PSCell report from the UE, and the successful PSCell report is caused by the configuration of the target SN, the source SN may directly transmit the successful PSCell report to the target SN via an inter-base station interface message or via a core network. The message includes the mobility information of the UE in the target PSCell. Or the source SN may transmit the successful PSCell report to the target SN via the source MN, or the source SN may transmit the successful PSCell report to the target SN via the source MN and the target MN.

If the source SN receives the successful PSCell report from the UE, and the successful PSCell report is caused by the configuration of the target MN, the source SN may directly transmit the successful PSCell report to the target MN via an inter-base station interface message or via a core network. Or the source SN may transmit the successful PSCell report to the target MN via the source MN.

If the source MN receives the successful PSCell report from the UE, and the successful PSCell report is caused by the configuration of the source SN, the source MN transmits the successful PSCell report to the source SN. If the successful PSCell report is caused by the configuration of the target SN, the source MN may directly transmit the successful PSCell report to the target SN via an inter-base station interface message or via a core network. Or the source MN may transmit the successful PSCell report to the target SN via the target MN.

So far, an embodiment III supporting self-configuration and self-optimization in accordance with the present disclosure is completed. With such a method, the successful handover report or the successful PSCell report may be supported to correctly identify the causes for potential failures, to perform reasonable optimization to avoid occurrence of failures, ensure service continuity and reduce the labour costs of operators.

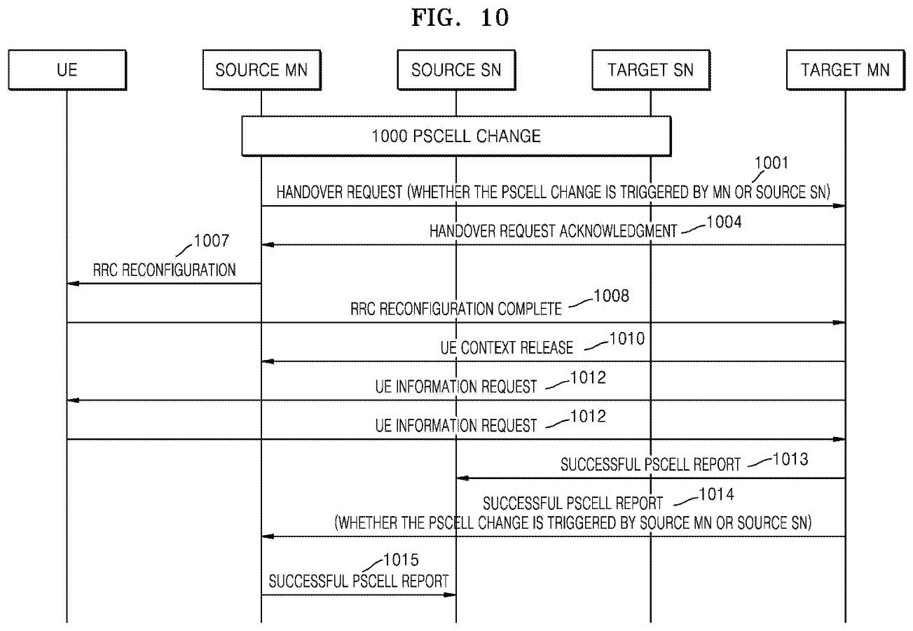

An example of an embodiment IV supporting self-configuration and self-optimization in accordance with the present disclosure is as shown in FIG. 10. Detailed description of steps unrelated to the present disclosure is omitted here. The method includes the following steps as shown in following examples.

In one example of Step 1000, a PSCell change process from a source SN to a target SN is executed, which may be a normal PSCell change or a conditional PSCell change. The PSCell change may be triggered by a MN or triggered by a source SN. The MN here is a source MN of handover.

In one example of Step 1001, a source MN transmits a handover request message to a target MN. The message includes the information whether the latest PSCell change is triggered by the MN or the source SN. The message further includes mobility information of UE in a PCell of the source MN, mobility information of the UE in a target PSCell, and/or mobility information of the UE in a source PSCell. For the method that the source MN obtains the mobility information of the UE in the source PSCell and the mobility information of the UE in the target PSCell, please refer to the description in FIG. 6 to FIG. 8. The message includes a C-RNTI of the UE in a source PCell, a C-RNTI of the UE in a target PSCell, and/or a C-RNTI of the UE in a source PSCell.

In one example of Step 1004, the target MN transmits a handover request acknowledgement message to the source MN. The handover request acknowledgement message includes a threshold value of a T304 configured by the target MN, which is used for the UE to determine to save and report a successful handover report. The message includes mobility information of the UE in the target MN, and/or a C-RNTI of the UE in a target PCell.

In one example of Step 1007, the source MN transmits an RRC reconfiguration message to the UE. The RRC reconfiguration message includes successful handover configuration information. The successful handover configuration information includes a threshold value of a T310 and/or a threshold value of a T312 configured by the source MN, and/or the threshold value of the T304 configured by the target MN.

In one example of Step 1008, the UE transmits an RRC reconfiguration complete message to the target MN. The message includes information that a successful PSCell report is available. The message may also include information that a successful handover report is available.

In one example of Step 1010, the target MN transmits a UE context release message to the source MN.

In one example of Step 1012, the target MN transmits a UE information request message to the UE to request the UE to report the successful PSCell report. If the target MN receives the information that the successful handover report is available, the target MN may also request the successful handover report at the same time.

The UE transmits the successful PSCell report to the MN. The content of the successful PSCell report is the same as that in Step 602 and will not be described in detail here. In addition, the successful PSCell report may also include the mobility information of the UE in the target PCell, and/or the C-RNTI of the UE in the target Pcell. If the target MN requests the successful handover report, the UE may also transmit the successful handover report to the target MN at the same time.

Which node brings the successful PSCell report can be determined in two methods.

The first method is determined by the target MN. The target MN determines which node brings the successful PSCell report according to the information of the PSCell change triggered by the MN or the source SN received in Step 1001 and/or the PSCell report received from the UE. Corresponding to this method, if the PSCell report is brought by the source MN, Step 1014 is executed. If the successful PSCell report is brought by the source SN or the target SN, there are two ways to transmit message to the source SN or the target SN.

In one example I, the target MN directly transmits the message to the source SN or the target SN, and Step 1013 is executed.

In one example II, the target MN transmits a message to the source MN, and the source MN transmits a message to the source SN or the target SN, and Steps 1014 and 1015 are executed.

The second method is that the target MN transmits a message to the source MN (Step 1014), the message transmitted by the target MN to the source MN includes information whether the latest PSCell change is initiated by the MN or the source SN. The source MN determines whether the PSCell report is brought by the MN, the source SN, or the target SN. If the PSCell report is brought by the source SN or the target SN, the source MN transmits a message to the source MN or the target SN (Step 1015).

In one example of Step 1013, the target MN transmits the successful PSCell report to the source SN or target SN.

The message includes the successful PSCell report, and the message also includes the information in Step 603, which will not be described in detail here. The message transmitted by the target MN to the target SN may also include the mobility information of the UE in the target PSCell, and/or the C-RNTI of the UE in the target PSCell. The message transmitted by the target MN to the source SN may also include the mobility information of the UE in the source PSCell, and/or the C-RNTI of the UE in the source PSCell.

The target MN transmits the information of the successful PSCell report to the source SN or the target SN via an access and mobility indication message or a newly defined message. The target MN may also transmit the successful PSCell report to the source SN or the target SN via other messages.

In one example of Step 1014, the target MN transmits the successful PSCell report to the source MN. The message includes the information whether the latest PSCell change is initiated by the MN or the source SN.

The target MN may transmit the successful PSCell report to the source MN via the access and mobility indication message or other messages, and the message may also include the information of the source PSCell, and/or the information of the target PSCell. The information of the source PSCell and the information of the target PSCell include a cell identifier of the cell and/or an identifier of a tracking area where the cell is located. The message may also include a C-RNTI allocated by the target PSCell to the UE, a C-RNTI allocated by the source PSCell to the UE, a C-RNTI allocated by the target primary cell to the UE, and/or a C-RNTI allocated by the source primary cell to the UE. The message may also include the mobility information of the UE in the source PSCell, the mobility information of the UE in the target PSCell, and/or the mobility information of the UE in the source primary cell.

Corresponding to a method for determining which node brings the successful PSCell report by the source MN, the source MN determines which node brings the successful PSCell report. The MN determines which node brings the successful PSCell report according to the received information whether the latest PSCell change is initiated by the MN or the source SN, the successful PSCell report from the UE, the information received from the target MN, and/or the information saved by the source MN. If the successful PSCell report is brought by the source MN, the MN performs the corresponding optimization. If the successful PSCell report is brought by the source SN or the target SN, Step 1015 is executed.

In one example of Step 1015, the source MN transmits the successful PSCell report to the source SN or target SN. The source MN may transmit the successful PSCell report to the source SN or the target SN via an access and mobility indication message or other messages. The message may also include the information of the source PSCell, and/or the information of the target PSCell. The message may also include the C-RNTI allocated by the target PSCell to the UE, and/or the C-RNTI allocated by the source PSCell to the UE. The message transmitted to the source SN may also include the mobility information of the UE in the source PSCell. The message transmitted to the target SN may also include the mobility information of the UE in the target PSCell.

The information of the source PSCell and the information of the target PSCell include a cell identifier of the cell and/or an identifier of a tracking area where the cell is located. The message may also include the C-RNTI allocated by the target PSCell to the UE, the C-RNTI allocated by the source PSCell to the UE, the C-RNTI allocated by the target primary cell to the UE, and/or the C-RNTI allocated by the source primary cell to the UE. The message includes the mobility information of the UE in the PCell of the source MN, and/or the mobility information of the UE in the source PSCell.

If the successful PSCell report is caused by the source SN, the source SN performs the corresponding optimization.

If the successful PSCell report is caused by the target SN, the target SN performs the corresponding optimization.

The target MN may also transmit the successful PSCell report to the source MN via the UE context release message.

If a fifth network node (other than the source MN, or the target MN, or the source SN, or the target SN) receives the information that the successful PSCell change is available and requests the successful PSCell report from the UE, a method for transmitting the successful PSCell report to a node configuring the successful PSCell change, or a node triggering the PSCell change, or a node needs to perform cause analysis, or a node needs to perform optimization is the same as that in Step 915, and will not be described in detail here.

If the target SN receives the successful PSCell report from the UE, a method for transmitting the successful PSCell report to the node configuring the successful PSCell change or the node triggering the PSCell change is the same as that in Step 915 and will not be described in detail here.

If the source SN receives the successful PSCell report from the UE, a method for transmitting the successful PSCell report to the node configuring the successful PSCell change or the node triggering the PSCell change is the same as that in Step 915 and will not be described in detail here.

So far, an embodiment IV supporting self-configuration and self-optimization in accordance with the present disclosure is completed. With such a method, the successful handover report or the successful PSCell report may be supported to correctly identify the causes for potential failures, to perform reasonable optimization to avoid occurrence of failures, ensure service continuity and reduce the labour costs of operators.

It should be noted that the above method is also applicable when at least two of the MN, the source SN and the target SN support the same radio access technology. For example, when the MN, the source SN and the target SN support the same radio access technology, the successful handover report or the successful PSCell report is encoded according to the RRC of the radio access technology supported by the MN, the source SN and the target SN, and the UE transmits the successful handover report or the successful PSCell report to the base station via an RRC message of the radio access technology. The specific base station to which the report is transmitted to is as described in various embodiments of the present disclosure.

So far, the method supporting self-configuration and self-optimization according to the present disclosure is completed. With such a method, the successful PSCell report may be supported to correctly identify the causes for potential failures, to perform reasonable optimization to avoid occurrence of failures, ensure service continuity and reduce the labour costs of operators.

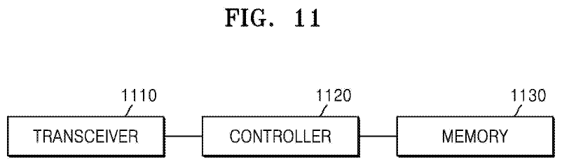

FIG. 11 illustrates a network node in a network according to embodiments of the present disclosure.

The network node in the network may be used to implement the UE, MN, SN, S-SN, T-SN, other candidate T-SN and the like in the present disclosure. Referring to FIG. 11, the network node according to the present disclosure includes a transceiver 1110, a controller 1120, and a memory 1130. The transceiver 1110, the controller 1120 and the memory 1130 are configured to perform operations of the methods and/or embodiments of the present disclosure. Although the transceiver 1110, the controller 1120 and the memory 1130 are shown as separate entities, they may be implemented as a single entity, such as a single chip. The transceiver 1110, the controller 1120 and the memory 1130 may be electrically connected or coupled to each other. The transceiver 1110 may transmit signals to, and receive signals from, other network nodes, such as UE, MN, SN, S-SN, T-SN, other candidate T-SN, or core network nodes. The controller 1120 may include one or more processing units and may control the network node to perform operations and/or functions according to one of the above embodiments. The memory 1130 may store instructions for implementing operations and/or functions of one of the above embodiments.

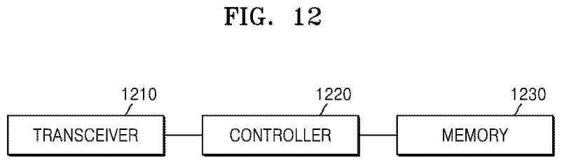

FIG. 12 illustrates a user equipment UE according to embodiments of the present disclosure.

Referring to FIG. 12, the UE according to the present disclosure includes a transceiver 1210, a controller 1220, and a memory 1230. The transceiver 1210, the controller 1220 and the memory 1230 are configured to perform operations of the methods and/or embodiments of the present disclosure. Although the transceiver 1210, the controller 1220 and the memory 1230 are shown as separate entities, they may be implemented as a single entity, such as a single chip. The transceiver 1210, the controller 1220 and the memory 1230 may be electrically connected or coupled to each other. The transceiver 1210 may be transmit signals to, and receive signals from, other network nodes, such as UE, MN, SN, S-SN, T-SN, other candidate T-SN, or core network nodes. The controller 1220 may include one or more processing units and may control the UE to perform operations and/or functions according to one of the above embodiments. The memory 1230 may store instructions for implementing operations and/or functions of one of the above embodiments.

Those skilled in the art will understand that the above illustrative embodiments are described herein and are not intended to be limiting. It should be understood that any two or more of the embodiments disclosed herein may be combined in any combination. Further, other embodiments may be utilized and other changes may be made without departing from the spirit and scope of the subject matter presented herein. It will be readily understood that various aspects of the disclosed present disclosure, as generally described herein and illustrated in the accompanying drawings, may be arranged, replaced, combined, separated, and designed in a variety of different configurations, all of which are contemplated herein.

Those skilled in the art will appreciate that the various illustrative logic blocks, modules, circuitry and steps described in the present application may be implemented as hardware, software or a combination of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system The described functionality may be implemented by those skilled in the art differently for each particular application but such design decisions should not be interpreted as causing departure from the scope of the present application.

The various illustrative logical blocks, modules, and circuits described in the present application may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors cooperate with a DSP core, or any other such configurations.

The steps of methods or algorithms described in the present application may be embodied directly in hardware, in a software module executed by a processor, or in a combination of the two. A software module may reside in RAM memory, flash memory, ROM memory, EPROM memory, EEPROM memory, registers, hard disk, a removable disk, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In an alternative, the processor and the storage medium may reside in the user terminal as discrete components.

In one or more exemplary design, the functions may be implemented in hardware, software, firmware, or any combination thereof. If implemented in software, the functions may be stored on or transmitted over as one or more instructions or code on a computer-readable medium. A computer-readable medium includes both a computer storage medium and a communication medium. The communication medium includes any medium that facilitates transfer of a computer program from one place to another. The storage medium may be any available medium that can be accessed by a general purpose or special purpose computer.

The foregoing is only an exemplary implementation of the present application and is not intended to limit the scope of protection of the present application which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE), the method comprising:
transmitting, to a base station, a first message including information that a successful primary secondary cell (PSCell) report is available;
receiving, from the base station, a second message requesting for the successful PSCell report; and
transmitting, to the base station, a third message including the successful PSCell report.

2. The method of claim 1, wherein in case that a conditional PSCell change (CPC) or conditional PSCell addition (CPA) is configured for the UE, the successful PSCell report includes information on a time elapsed between execution of the CPC or CPA and reception of configuration information for the CPC or CPA.

3. The method of claim 1, wherein the successful PSCell report includes information about whether a PSCell change associated with the successful PSCell report is initiated by a secondary node (SN).

4. The method of claim 1, wherein the successful PSCell report includes at least one of:
cell information for at least one of a primary cell (PCell), a source PSCell, and a target PSCell,
location information of the UE,
a measurement result of the UE, and
common random access information.

5. The method of claim 1, wherein in case that the base station is not associated with a master node (MN) serving the UE at a time of successful PSCell change, the successful PSCell report is transmitted to the MN.

6. A method performed by a base station, the method comprising:
receiving, from a user equipment (UE), a first message including information that a successful primary secondary cell (PSCell) report is available;
transmitting, to the UE, a second message requesting for the successful PSCell report; and
receiving, from the UE, a third message including the successful PSCell report.

7. The method of claim 6, wherein in case that a conditional PSCell change (CPC) or conditional PSCell addition (CPA) is configured for the UE, the successful PSCell report includes information on a time elapsed between execution of the CPC or CPA and reception by the UE of configuration information for the CPC or CPA.

8. The method of claim 6, wherein the successful PSCell report includes information about whether a PSCell change associated with the successful PSCell report is initiated by a secondary node (SN).

9. The method of claim 6, wherein the successful PSCell report includes at least one of:
cell information for at least one of a primary cell (PCell), a source PSCell, and a target PSCell,
location information of the UE,
a measurement result of the UE, and
common random access information.

10. The method of claim 6, further comprising:
in case that the base station is not associated with a master node (MN) serving the UE at a time of successful PSCell change, transmitting, to the MN, the successful PSCell report.

11. A user equipment (UE) in a wireless communication system, the UE comprising:
a transceiver; and
a controller configured to:
transmit, to a base station via the transceiver, a first message including information that a successful primary secondary cell (PSCell) report is available,
receive, from the base station via the transceiver, a second message requesting for the successful PSCell report, and
transmit, to the base station via the transceiver, a third message including the successful PSCell report.

12. The UE of claim 11, wherein in case that a conditional PSCell change (CPC) or conditional PSCell addition (CPA) is configured for the UE, the successful PSCell report includes information on a time elapsed between execution of the CPC or CPA and reception of configuration information for the CPC or CPA.

13. The UE of claim 11, wherein the successful PSCell report includes information about whether a PSCell change associated with the successful PSCell report is initiated by a secondary node (SN).

14. The UE of claim 11, wherein the successful PSCell report includes at least one of:
cell information for at least one of a primary cell (PCell), a source PSCell, and a target PSCell,
location information of the UE,
a measurement result of the UE, and
common random access information.

15. The UE of claim 11, wherein in case that the base station is not associated with a master node (MN) serving the UE at a time of successful PSCell change, the successful PSCell report is transmitted to the MN.

16. A base station in a wireless communication system, the base station comprising:
a transceiver; and
a controller configured to:
receive, from a user equipment (UE) via the transceiver, a first message including information that a successful primary secondary cell (PSCell) report is available,
transmit, to the UE via the transceiver, a second message requesting for the successful PSCell report, and
receive, from the UE via the transceiver, a third message including the successful PSCell report.

17. The base station of claim 16, wherein in case that a conditional PSCell change (CPC) or conditional PSCell addition (CPA) is configured for the UE, the successful PSCell report includes information on a time elapsed between execution of the CPC or CPA and reception by the UE of configuration information for the CPC or CPA.

18. The base station of claim 16, wherein the successful PSCell report includes information about whether a PSCell change associated with the successful PSCell report is initiated by a secondary node (SN).

19. The base station of claim 16, wherein the successful PSCell report includes at least one of:
cell information for at least one of a primary cell (PCell), a source PSCell, and a target PSCell,
location information of the UE,
a measurement result of the UE, and
common random access information.

20. The base station of claim 16, wherein the controller is further configured to:
in case that the base station is not associated with a master node (MN) serving the UE at a time of successful PSCell change, transmit, to the MN via the transceiver, the successful PSCell report.
